(19) United States
(12) Patent Application Publication
(10) Pub. No.: US 2026/0235714 A1
(43) Pub. Date: Aug. 13, 2026

(54) MACHINE LEARNING FOR POSITIONING

(71) Applicant: LENOVO (SINGAPORE) PTE. LTD., Singapore (SG)

(72) Inventors: Robin Rajan Thomas, Bad Nauheim (DE); Vahid Pourahmadi, Müchhen (DE); Venkata Srinivas Kothapalli, Aurora, IL (US)

(73) Assignee: LENOVO (SINGAPORE) PTE. LTD., Singapore (SG)

(21) Appl. No.: 19/154,104

(22) PCT Filed: Feb. 6, 2024
(86) PCT No.: PCT/IB2024/051100

§ 371 Date: Aug. 6, 2025

Related U.S. Application Data
(60) Provisional application No. 63/444,469, filed on Feb. 9, 2023.
(60) Provisional application No. 63/484,102, filed on Feb. 9, 2023.

(51) Int. Cl. G01S 5/02; G06N 20/00; H04W 64/00

(52) U.S. Cl. CPC G01S 5/0244; G01S 5/0252; G06N 20/00; H04W 64/00

(57) ABSTRACT

Various aspects of the present disclosure relate to methods, apparatuses, and systems that support machine learning for positioning. For instance, implementations provide for direct Artificial Intelligence (AI)-based positioning and AI-assisted positioning which can be leveraged to improve User Equipment (UE) location accuracy performance. In example implementations, for direct AI/Machine Learning (ML) positioning, techniques such as fingerprinting can be leveraged by AI/ML models to obtain enhanced location accuracies, such as via measurement and environmental data. Accordingly, the present disclosure provides techniques to configure direct AI/ML positioning assistance data as well as define measurements to perform AI/ML direct positioning. Further, the present disclosure provides techniques to configure reporting criteria for nodes and/or other entities performing AI/ML direct positioning measurements.

### RELATED APPLICATIONS

This application claims priority to U.S. Provisional Application Ser. No. 63/484,102 filed 9 Feb. 2023 entitled “MACHINE LEARNING FOR POSITIONING,” and U.S. Provisional Application Ser. No. 63/444,469, filed 9 Feb. 2023 entitled “MACHINE LEARNING FOR POSITIONING,” the disclosures of which are incorporated by reference herein in their entirety.

### TECHNICAL FIELD

The present disclosure relates to wireless communications, and more specifically to position determination in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for determining device (e.g., UE) position, such as geographical position of a UE. Current implementations for UE positioning, however, may be imprecise.

### SUMMARY

The present disclosure relates to methods, apparatuses, and systems that support machine learning for positioning. For instance, implementations provide for direct artificial intelligence/machine learning (AI/ML)-based positioning and AI/ML-assisted positioning which can be leveraged to improve UE location accuracy performance. In example implementations, for direct AI/ML positioning, techniques such as fingerprinting can be leveraged by AI/ML models to obtain enhanced location accuracies, such as via measurement and environmental data. Accordingly, the present disclosure provides techniques to configure direct AI/ML positioning assistance data as well as define measurements to perform AI/ML direct positioning. Further, the present disclosure provides techniques to configure reporting criteria for nodes and/or other entities performing AI/ML direct positioning measurements.

Thus, by utilizing the described techniques, more accurate positioning of UEs can be obtained and usage of system resources for determining UE position can be reduced.

Some implementations of the methods and apparatuses described herein may further include transmitting one or more machine learning positioning report requests including a machine learning reporting configuration and one or more common reporting criteria; receiving one or more machine learning positioning reports; processing the one or more machine learning positioning reports via a machine learning model; and generating, based at least in part on output from the machine learning model, an estimated location of a user equipment (UE).

Some implementations of the methods and apparatuses described herein may further include: where the machine learning reporting configuration includes one or more of direct machine learning reporting configuration or assisted machine learning reporting configuration; wherein the method if performed by an apparatus including a configuration entity, and wherein the configuration entity includes at least one of a location server, a next generation radio access network (NG-RAN), a positioning reference unit (PRU), a UE, an anchor UE, or a target UE; further including transmitting the one or more machine learning positioning report requests from a first apparatus to one or more second apparatus, and receiving the one or more machine learning positioning reports from the one or more second apparatus, and wherein the one or more second apparatus include at least one of a location server, a next generation radio access network (NG-RAN), a positioning reference unit (PRU), a UE, an anchor UE, or a target UE.

Some implementations of the methods and apparatuses described herein may further include: where the one or more common reporting criteria include one or more of a fingerprint type, a ground truth reference location type, a time domain reporting type, a pre-processing of measurements, a measurement validity, a UE type, a mobility indication, an orientation indication, a fingerprinting environment indication, a fingerprint quality indication, or a label quality indication; wherein for at least one machine learning positioning report request, the one or more of the common reporting criteria are configured to be one or more of augmented, removed, updated, activated, or deactivated; further including broadcasting the one or more common reporting criteria via positioning system information broadcast signaling; wherein the machine learning reporting configuration includes an indication to report machine learning positioning measurement correlation amongst different sets of measurements.

Some implementations of the methods and apparatuses described herein may further include: where the machine learning positioning measurement correlation includes one or more of spatial domain correlation or time domain correlation; wherein the one or more machine learning positioning reports include one or more of machine learning positioning measurements or machine learning positioning location information; wherein the machine learning reporting configuration includes an indication to report pathloss at different locations including a ground truth reference location; wherein the machine learning reporting configuration includes an indication to average machine learning positioning measurements over a configured number of measurements and report the average as part of the one or more machine learning positioning reports; wherein the machine learning reporting configuration includes an indication to determine a similarity score at a configured location to determine an optimal mapping between a fingerprint measurement and an estimated location of a target UE.

Some implementations of the methods and apparatuses described herein may further include receiving one or more machine learning positioning report requests including a machine learning reporting configuration and one or more common reporting criteria; generating one or more machine learning positioning reports based at least in part on the machine learning reporting configuration and the one or more common reporting criteria; and transmitting the one or more machine learning positioning reports.

Some implementations of the methods and apparatuses described herein may further include: where the method is performed by an apparatus including one or more of a user equipment (UE) an anchor UE, or a target UE; wherein the method is performed by an apparatus including a configuration entity, and wherein the configuration entity includes at least one of a location server, a next generation radio access network (NG-RAN), or a positioning reference unit (PRU)

Some implementations of the methods and apparatuses described herein may further include transmitting one or more machine learning positioning report requests including a machine learning reporting configuration and one or more common reporting criteria; receiving one or more machine learning positioning reports; generating, based at least in part on the one or more machine learning positioning reports, a machine learning positioning training data set; and training a positioning machine learning model using the machine learning positioning training data set to generate a trained positioning machine learning model.

Some implementations of the methods and apparatuses described herein may further include receiving one or more further machine learning positioning reports; inputting at least a portion of the one or more further machine learning positioning reports to the trained positioning machine learning model; and estimating a position of a target user equipment (UE) based at least in part on output from the trained positioning machine learning model; further including: receiving a request for machine learning positioning training data for positioning; and transmitting, based at least in part on the request, the machine learning positioning training data set; further including: receiving a request for a trained positioning machine learning model; and transmitting, based at least in part on the request, at least a portion of the trained positioning machine learning model.

### BRIEF DESCRIPTION OF THE DRAWINGS

FIG. 1 illustrates an example of a wireless communications system that supports machine learning for positioning in accordance with aspects of the present disclosure.

FIG. 2 illustrates a system in which positioning reference signals can be utilized to obtain positioning measurements.

FIG. 3 illustrates a scenario for a multi-cell RTT positioning.

FIGS. 4a and 4b illustrate portions of an LPP RequestLocationInformation message.

FIGS. 5a and 5b illustrate portions of an LPP ProvideLocationInformation message.

FIG. 6 illustrates a system for machine learning-based RAN intelligence.

FIG. 7 illustrates an example scenario that supports machine learning for positioning in accordance with aspects of the present disclosure.

FIG. 8 illustrates an example scenario that supports machine learning for positioning in accordance with aspects of the present disclosure.

FIG. 9 illustrates a message that supports machine learning for positioning in accordance with aspects of the present disclosure.

FIGS. 10a and 10b illustrate different portions of a message that supports machine learning for positioning in accordance with aspects of the present disclosure.

FIG. 11 illustrates a message that supports machine learning for positioning in accordance with aspects of the present disclosure.

FIG. 12 illustrates a message that supports machine learning for positioning in accordance with aspects of the present disclosure.

FIG. 13 illustrates scenarios that support machine learning for positioning in accordance with aspects of the present disclosure.

FIGS. 14a and 14b illustrate scenarios that support machine learning for positioning in accordance with aspects of the present disclosure.

FIG. 15 illustrates a scenario that supports machine learning for positioning in accordance with aspects of the present disclosure.

FIG. 16 illustrates a scenario that supports machine learning for positioning in accordance with aspects of the present disclosure.

FIG. 17 illustrates a scenario that supports machine learning for positioning in accordance with aspects of the present disclosure.

FIGS. 18 and 19 illustrate example block diagrams of devices that support machine learning for positioning in accordance with aspects of the present disclosure.

FIGS. 20 through 25 illustrate flowcharts of methods that support machine learning for positioning in accordance with aspects of the present disclosure.

### DETAILED DESCRIPTION

In wireless communications systems, techniques are utilized to estimate a position (e.g., location) of a UE, such as a geographical position of the UE and/or a relative network location of the UE. For instance, some systems utilize beam-based attempts to estimate UE location, such as in commercial and regulatory (e.g., emergency) scenarios. Current position determination techniques, however, may be imprecise and result in inaccurate indications of UE location.

Accordingly, this disclosure provides for techniques that support machine learning for positioning. For instance, implementations provide for direct AI-based positioning and AI-assisted positioning which can be leveraged to improve UE location accuracy performance, such as within a 3GPP-defined positioning framework. For instance, for direct AI/ML positioning, techniques such as fingerprinting can be leveraged by AI/ML models to obtain enhanced location accuracies, such as via measurement and environmental data. Accordingly, the present disclosure provides techniques to configure direct AI/ML positioning assistance data as well as define measurements to perform AI/ML direct positioning. Further, the present provides techniques to configure reporting criteria for nodes and/or other entities performing AI/ML direct positioning measurements.

Thus, by utilizing the described techniques, more accurate positioning of UEs can be obtained by leveraging large amounts of radio and other related data and usage of system resources for determining UE position can be reduced.

Aspects of the present disclosure are described in the context of a wireless communications system. Aspects of the present disclosure are further illustrated and described with reference to device diagrams and flowcharts.

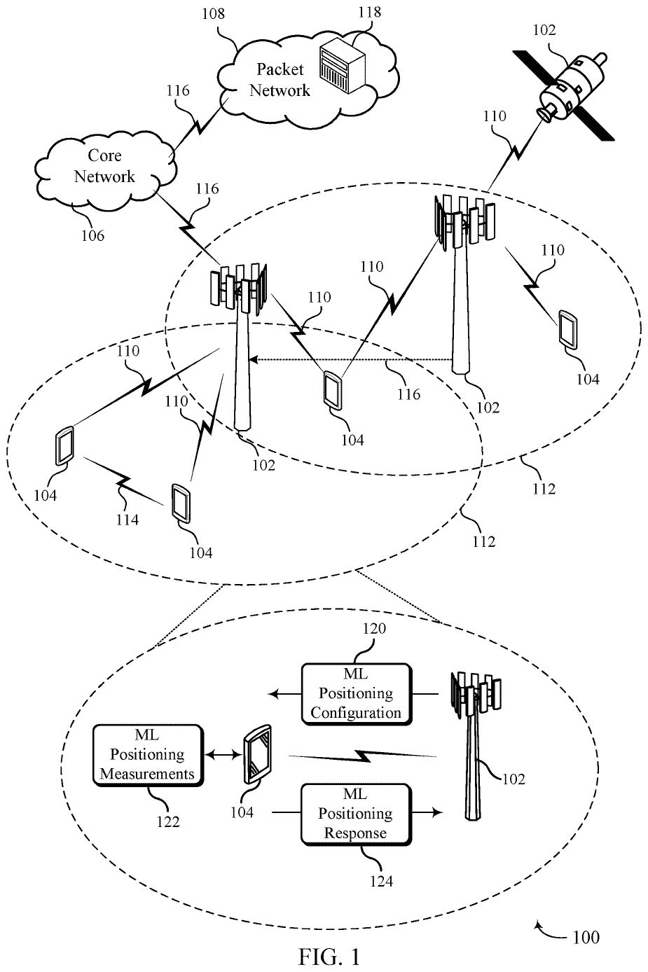

FIG. 1 illustrates an example of a wireless communications system 100 that supports machine learning for positioning in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a location management function (LMF), which is a control plane entity that manages location-related services, a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for machine learning for positioning, a network entity 102 transmits an ML positioning configuration to a UE 104. The ML positioning configuration 120, for instance, includes various information and/or parameters for the UE 104 to measure various positioning information, to generate positioning measurements, and/or to process positioning measurements. Accordingly, based at least in part on the ML positioning configuration 120, the UE 104 performs ML positioning measurements 122, such as to measure and process various attributes of wireless signal detected at the UE 104. The UE 104 generates an ML positioning response 124 based at least in part on the ML positioning measurements 122 and/or the ML positioning configuration 120 and transmits the ML positioning response to the network entity 102. In implementations, the ML positioning response 124 may include an estimated position (e.g., location) of the UE 104 and/or the network entity 102 may utilize ML techniques to process the ML positioning response to estimate a position of the UE 104.

In some wireless communications systems, NR positioning based on NR Uu signals and standalone (SA) architecture (e.g. beam-based transmissions) are specified. The target use cases include commercial and regulatory (emergency services) scenarios. The performance parameters include the following [Technical Report (TR) 38.855]:

| Positioning Error | Indoor | Outdoor |
|---|---|---|
| Horizontal | <3 m for 80% of UEs | <10 m for 80% of UEs |
| Positioning | | |
| Vertical | <3 m for 80% of UEs | <3 m for 80% of UEs |
| Positioning | | |

Further, some systems specify positioning performance parameters for commercial and IIoT use cases as follows [TR 38.857]:

| Positioning Error | Commercial | IIOT |
|---|---|---|
| Horizontal Positioning | (<1 m) for 90% of | (<0.2 m) for 90% |
| | UEs | of UEs; |
| Vertical Positioning | (<3 m) for 90% of | (<1 m) for 90% of |
| | UEs | UEs |
| Physical layer latency for | (<10 ms) | (<10 ms) |
| position estimation of UE | | |
| End-to-End Latency for | (<100 ms) | (<100 ms, in the order |
| position estimation of UE | | of 10 ms is desired) |

At least some supported positioning techniques are as follows in Table 1 [TS38.305]:

TABLE 1

| | | UE- | NG- | |
|---|---|---|---|---|
| | | assisted, | RAN | |
| | UE- | LMF- | node | |
| Method | based | based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AOD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

NOTE 1:
This includes Terrestrial Beacon System (TBS) positioning based on PRS signals.
NOTE 2:
In this version of the specification only OTDOA based on LTE signals is supported.
NOTE 3:
Void.
NOTE 4:
This includes Cell-Identifier (Cell-ID) for NR method.
NOTE 5:
In this version of the specification only for TBS positioning based on Metropolitan Beacon System (MBS) signals.
NOTE 6:
Void

Separate positioning techniques as indicated in Table 1 can be currently configured and performed based on the requirements of the LMF and UE capabilities. The transmission of Positioning Reference Signals (PRS) enables the UE to perform UE positioning-related measurements to enable the computation of a UE's location estimate and are configured per Transmission Reception Point (TRP), where a TRP may transmit one or more beams.

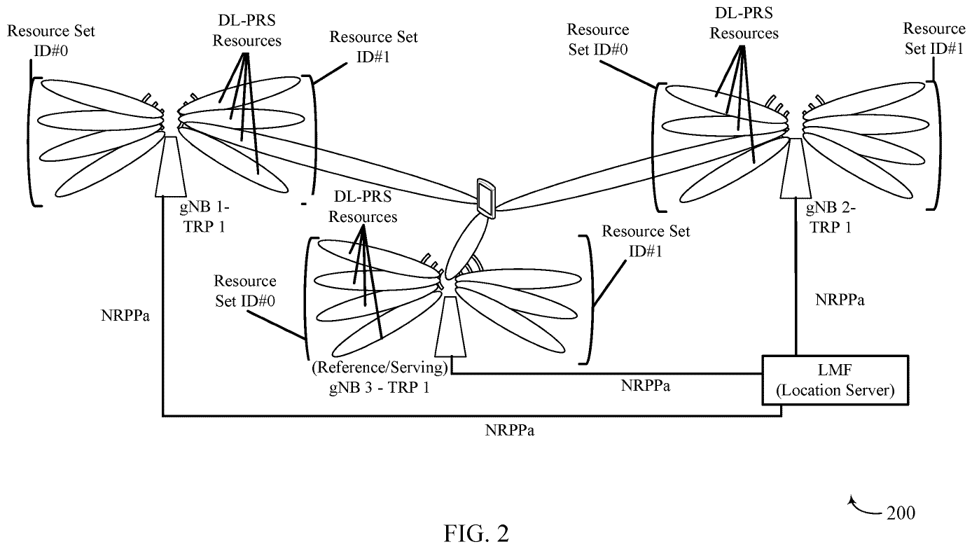

FIG. 2 illustrates a system 200 in which positioning reference signals can be utilized to obtain positioning measurements. For instance, PRS can be transmitted by different base stations (serving and neighboring) using narrow beams over FR1 and FR2, which is relatively different when compared to LTE where the PRS was transmitted across the whole cell. The PRS can be locally associated with a PRS Resource identifier (ID) and Resource Set ID for a base station (TRP). Similarly, UE positioning measurements such as Reference Signal Time Difference (RSTD) and PRS RSRP measurements are made between beams (e.g., between a different pair of downlink (DL) PRS resources or DL PRS resource sets) as opposed to different cells as was the case in LTE. In addition, there are additional UL positioning methods for the network to exploit in order to compute the target UE's location.

Table 2 and Table 3 show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, Inertial Measurement Unit (IMU) sensor, WLAN and Bluetooth technologies for performing target device (UE) positioning.

TABLE 2
UE Measurements to enable RAT-dependent positioning techniques

| | | To facilitate support of |
|---|---|---|
| DL/UL Reference | | the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/Rel. 16 | UE Rx-Tx time | Multi-RTT |
| SRS for positioning | difference | |
| Rel. 15 SSB/CSI-RS for | SS-RSRP(RSRP for | E-CID |
| Radio Resource | RRM), SS-RSRQ(for | |
| Management (RRM) | RRM), CSI-RSRP (for | |
| | RRM), CSI-RSRQ (for | |
| | RRM), SS-RSRP (for | |
| | RRM) | |

TABLE 3
gNB Measurements to enable RAT-dependent positioning techniques

| | | To facilitate support of the |
|---|---|---|
| | gNB | following positioning |
| DL/UL Reference Signals | Measurements | techniques |
| Rel. 16 SRS for positioning | UL RTOA | UL-TDOA |
| Rel. 16 SRS for positioning | UL SRS-RSRP | UL-TDOA, UL-AoA, |
| | | Multi-RTT |
| Rel. 16 SRS for | gNB Rx-Tx time | Multi-RTT |
| positioning, | | |
| Rel. 16 DL PRS | difference | |
| Rel. 16 SRS for positioning | AoA and ZoA | UL-AoA, Multi-RTT |

The following RAT-dependent positioning techniques can be supported [TS38.305]:

Downlink time difference of arrival (DL-TDOA) positioning methods make use of the DL Reference Signal Time Difference (RSTD) (and optionally DL PRS Reference Signal Received Power (RSRP)) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

DL AoD positioning methods make use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

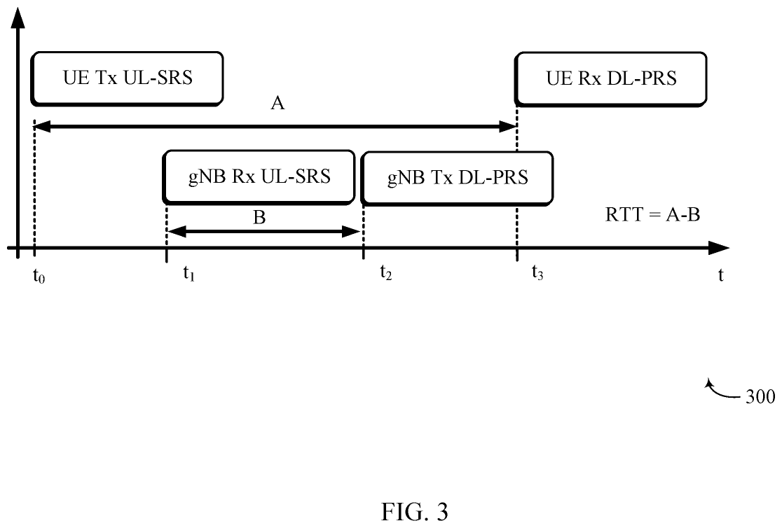

FIG. 3 illustrates a scenario 300 for a multi-cell round trip time (RTT) positioning. Multi-Round Trip Time (RTT) positioning methods make use of the UE Rx-Tx measurements and DL PRS RSRP of downlink signals received from multiple TRPs, measured by the UE and the measured gNB Rx-Tx measurements and Uplink (UL) Sounding Reference Signal (SRS)-RSRP at multiple TRPs of uplink signals transmitted from UE. The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE.

In an Enhanced Cell Identifier (E-CID) positioning method, the position of a UE is estimated with the knowledge of its serving ng-eNB, gNB and cell and is based on LTE signals. The information about the serving ng-eNB, gNB and cell may be obtained by paging, registration, or other methods. NR E-CID positioning refers to techniques which use additional UE measurements and/or NR radio resource and other measurements to improve the UE location estimate using NR signals. Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL TDOA positioning methods make use of the UL TDOA (and optionally UL SRS-RSRP) at multiple receive points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

UL AoA positioning methods make use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

RAT-Independent positioning techniques can also be implemented, including [TS38.305]:

Network-assisted Global Navigation Satellite System (GNSS) methods: These methods make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, GLONASS, and BeiDou Navigation Satellite System (BDS). Regional navigation satellite systems include Quasi Zenith Satellite System (QZSS) while some augmentation systems are classified under the generic term of Space Based Augmentation Systems (SBAS) and provide regional augmentation services. In this concept, different GNSSs (e.g. GPS, Galileo, etc.) can be used separately or in combination to determine the location of a UE.

Barometric pressure sensor positioning: The barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE.

Wireless Local Area Network (WLAN) positioning: The WLAN positioning method makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server to determine its location.

Bluetooth positioning: The Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

TBS positioning: A TBS consists of a network of ground-based transmitters, broadcasting signals only for positioning purposes. The current type of TBS positioning signals are the MBS (Metropolitan Beacon System) signals and PRS (Technical Specification (TS) 36.211 [4]). The UE measures received TBS signals, optionally aided by assistance data, to calculate its location or to send measurements to the positioning server for position calculation.

Motion sensor positioning: The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method can be used with other positioning methods for hybrid positioning.

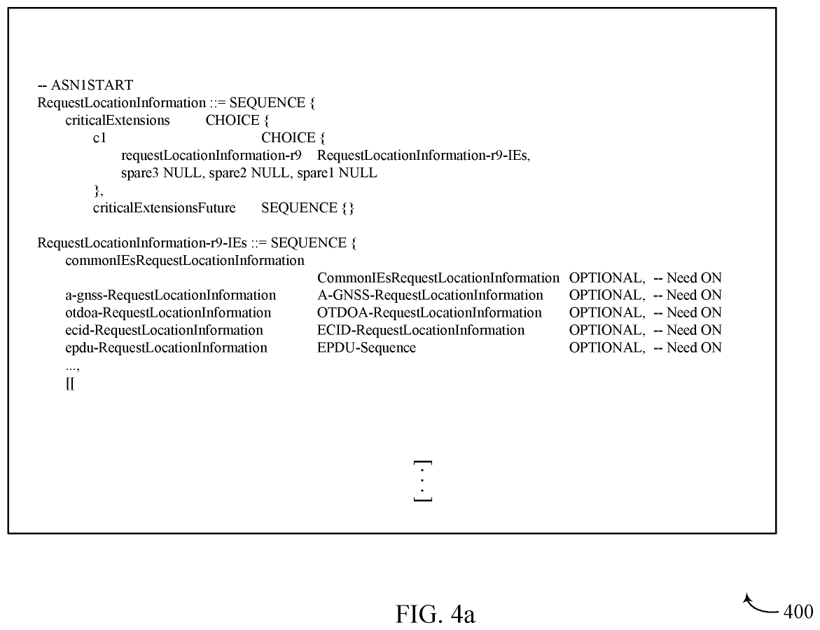

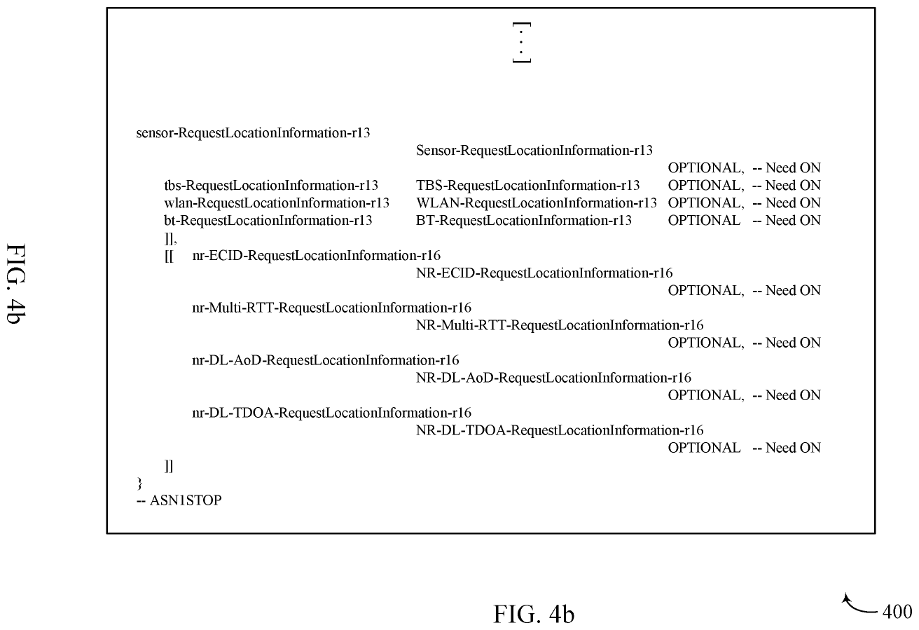

FIGS. 4a and 4b illustrate portions of an LPP RequestLocationInformation message 400. The RequestLocationInformation message 400 body in an LPP message can be used by the location server to request positioning measurements or a position estimate from the target device.

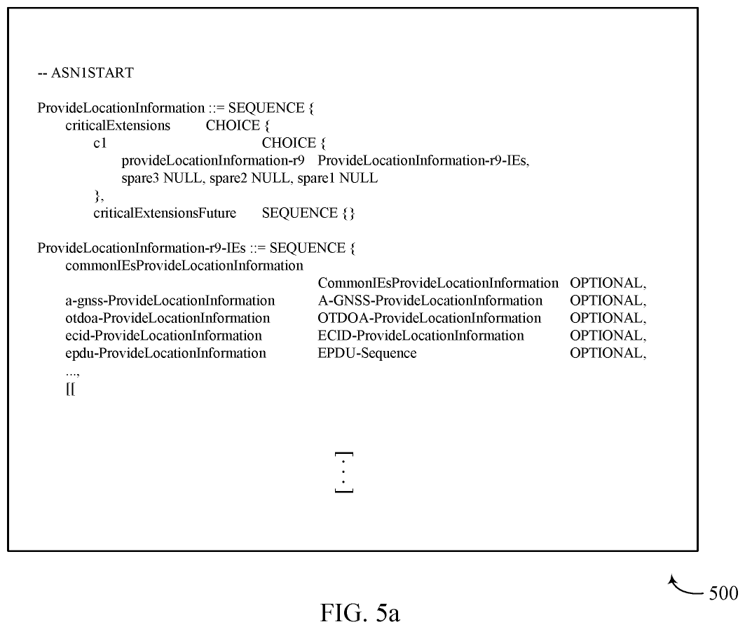

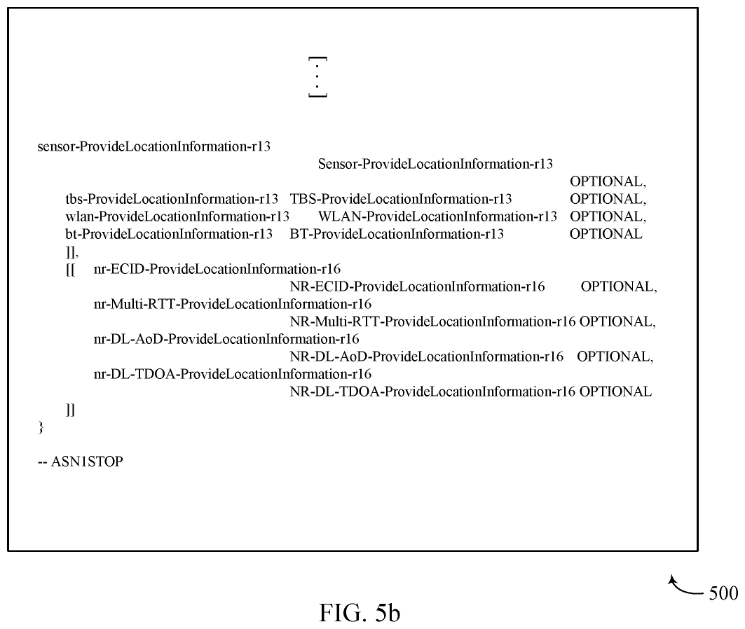

FIGS. 5a and 5b illustrate portions of an LPP ProvideLocationInformation message 500. The Provide LocationInformation message 500 body in a LPP message can be used by the target device to provide positioning measurements or position estimates to the location server.

For RAT-dependent positioning measurements, different DL measurements including DL PRS-RSRP, DL RSTD and UE Rx-Tx Time Difference used for the supported RAT-dependent positioning techniques are shown in Table 4 below. For instance, the following measurement configurations are specified [TS38.215]:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 4
DL Measurements required for DL-based positioning methods [TS38.215]
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements within |
| | the considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than the |
| | corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement shall be the |
| | Rx antenna connector of the UE and the reference point for T_{UE-IX} measurement |
| | shall be the Tx antenna connector of the UE. For frequency range 2, the |
| | reference point for T_{UE-RX} measurement shall be the Rx antenna of the UE and |
| | the reference point for T_{UE-TX} measurement shall be the Tx antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined as |
| | the power of the linear average of the channel response at the i-th path delay of |
| | the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be the |
| | antenna connector of the UE. For frequency range 2, DL PRS-RSRPP shall be |
| | measured based on the combined signal from antenna elements corresponding |
| | to a given receiver branch. |
| Applicable for | RRC_CONNECTED, |
| | RRC_INACTIVE |

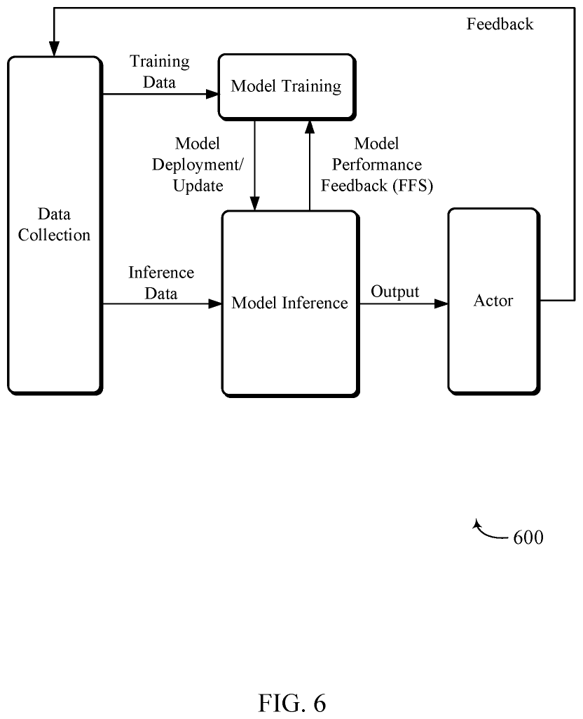

FIG. 6 illustrates a system 600 for machine learning-based RAN intelligence. In the system 600, Data Collection is a function that provides input data to Model Training and Model Inference functions. AI/ML algorithm specific data preparation (e.g., data pre-processing and cleaning, formatting, and transformation) may not be carried out in the Data Collection function. Examples of input data may include measurements from UEs or different network entities, feedback from Actor, output from an AI/ML model.
Training Data: Data needed as input for the AI/ML Model Training function.
Inference Data: Data needed as input for the AI/ML Model Inference function.

Model Training is a function that performs the ML model training, validation, and testing which may generate model performance metrics as part of the model testing procedure. The Model Training function is also responsible for data preparation (e.g. data pre-processing and cleaning, formatting, and transformation) based on Training Data delivered by a Data Collection function.

Model Deployment/Update: Used to initially deploy a trained, validated, and tested AI/ML model to the Model Inference function or to deliver an updated model to the Model Inference function.

Model Inference is a function that provides AI/ML model inference output (e.g. predictions or decisions). The Model Inference function is also responsible for data preparation (e.g. data pre-processing and cleaning, formatting, and transformation) based on Inference Data delivered by a Data Collection function, if required.

Output: The inference output of the AI/ML model produced by a Model Inference function.

Model Performance Feedback: Applied if certain information derived from Model Inference function is suitable for improvement of the AI/ML model trained in Model Training function. Feedback from Actor or other network entities (via Data Collection function) may be needed at Model Inference function to create Model Performance Feedback.

Actor is a function that receives the output from the Model inference function and triggers or performs corresponding actions. The Actor may trigger actions directed to other entities or to itself.

Feedback: Information that may be used to derive training or inference data or performance feedback.

Accordingly, solutions are provided in this disclosure that support machine learning for positioning. For instance, direct AI-based positioning and AI-assisted positioning methods can be leveraged to improve a UE's location accuracy performance. In scenarios for direct AI/ML positioning, techniques such as fingerprinting can be leveraged by AI/ML models to obtain enhanced location accuracies using measurement and environmental data. The present disclosure describes techniques to configure direct AI/ML positioning assistance data as well as to define measurements to perform AI/ML direct positioning. Further, the present disclosure describes techniques to configure reporting criteria for devices, nodes, and/or entities performing AI/ML direct positioning measurements.

Regarding aspects of the present disclosure, implementations are described for: configuration of a target-UE, positioning reference unit (PRU) UE, sidelink (SL) UE or NG-RAN node to perform direct AI/ML positioning measurements based on positioning reference signal transmission to generate a training dataset; enabling a target-UE, PRU UE, SL UE or NG-RAN node to perform requested measurements for different scenarios, which may form part of fingerprint based on the environment topology and AI/ML measurement parameters; for enabling a target-UE, PRU UE, NG-RAN node, configuration entity, SL UE, and/or location server to indicate AI/ML positioning assistance data or measurement error causes; for enabling a reporting configuration framework of a target-UE, PRU UE, SL UE, and/or NG-RAN node to receive the desired direct AI/ML positioning measurements, e.g., fingerprinting information; for enabling a plurality of common reporting criteria for AI/ML positioning measurements; for enabling configuration and reporting of assistance information to accurately report AI/ML positioning measurements.

A few notes regarding implementations described in this disclosure: The different implementations are combinable with one another and in various ways; a positioning-related reference signal may be referred to as a reference signal used for positioning procedures and/or purposes to estimate a target-UE's location, e.g., PRS, signal based on existing reference signals such as channel state information (CSI) reference signal (RS) (CSI-RS) or SRS, etc.; a target UE may be referred to as a device and/or entity to be localized and/or positioned; the term ‘PRS’ may refer to any signal such as a reference signal, which may or may not be used primarily for positioning; a target-UE may be referred to as a UE of interest whose position (e.g., absolute and/or relative) is to be obtained by the network and/or by the UE itself; the terms AI and ML may be used to interchangeably to refer to an intelligent software component or system, and AI may represent a subset and/or implementation of ML; a reference made to device position and/or location information may refer to a 2D/3D absolute position, relative position with respect to another node and/or entity, ranging in terms of distance, ranging in terms of direction, and combinations thereof.

Implementations disclosed herein support configuration of direct AI/ML positioning measurements and processing. For instance, fingerprinting is described, such as where an inference AI/ML model may be deployed at different entities. Examples of such implementations include UE-based positioning with a UE-side ML mode, UE-assisted and/or LMF-based positioning with LMF-side ML model, NG-RAN node assisted positioning with LMF-side ML model, etc.

In implementations that include UE-based positioning, a target UE may request training datasets based on DL and SL reference signals (e.g., DL-PRS, SL-PRS, etc.) from various data sources including measurements performed and collected internally within the target UE, other UEs, a location server, an NG-RAN node, PRU, network operation, administration and maintenance (OAM), trace collection entities (TCE), and/or combinations thereof. The training datasets may include reference points and/or reference locations, and fingerprint information and/or other positioning measurements can be sampled, measured, and/or associated. Various network entities and/or nodes may be enabled with the following procedures to enable configuration:
A target UE, anchor UE, and/or PRU UE may transmit a request and receive a response including configuration for downlink (DL) direct AI/ML positioning assistance (e.g., configuration) data, e.g., fingerprinting with respect to a location server;
A target UE may transmit a request and receive training data (e.g., instead of configuration for performing measurement) or instructions to obtain the training data from a second node, e.g., a location server, an NG-RAN node, positioning reference units, network OAM, TCE, or combinations thereof;
Another node (e.g., the location server, NG-RAN node, and/or another node) may transmit a request to the target UE to receive training data that the target UE has collected and/or measured;
A location server may receive DL direct AI/ML positioning assistance (e.g., configuration) data, e.g., for a radio frequency (RF) fingerprinting request from a plurality of UEs including the target UE and PRU UE, and the location server may provide a configuration response;
One or more UEs including an anchor UE and/or PRU UE may receive a request for SL direct AI/ML positioning assistance data (e.g., configuration and/or RF fingerprinting) and may provide a suitable configuration response.

In implementations that include UE-assisted positioning, a location server may request a plurality of training datasets based on DL and SL reference signals (e.g., DL-PRS, SL-PRS) from various data sources including measurements collected internally within the location server, multiple UEs, other neighboring location servers, NG-RAN nodes, positioning reference units, and combination thereof. These datasets may contain reference points and/or reference locations, where fingerprint information can be sampled, measured, and/or associated. Various network entities and/or nodes may be enabled with the following functionality to enable such implementations:
The location server may transmit a downlink (DL) or sidelink (SL) Direct AI/ML positioning assistance (configuration), e.g., fingerprinting data.
At least one or more UEs including the target UE or PRU UE may receive a response/configuration for a DL and/or SL AI/ML Direct positioning configuration, e.g., fingerprinting with respect to a location server.

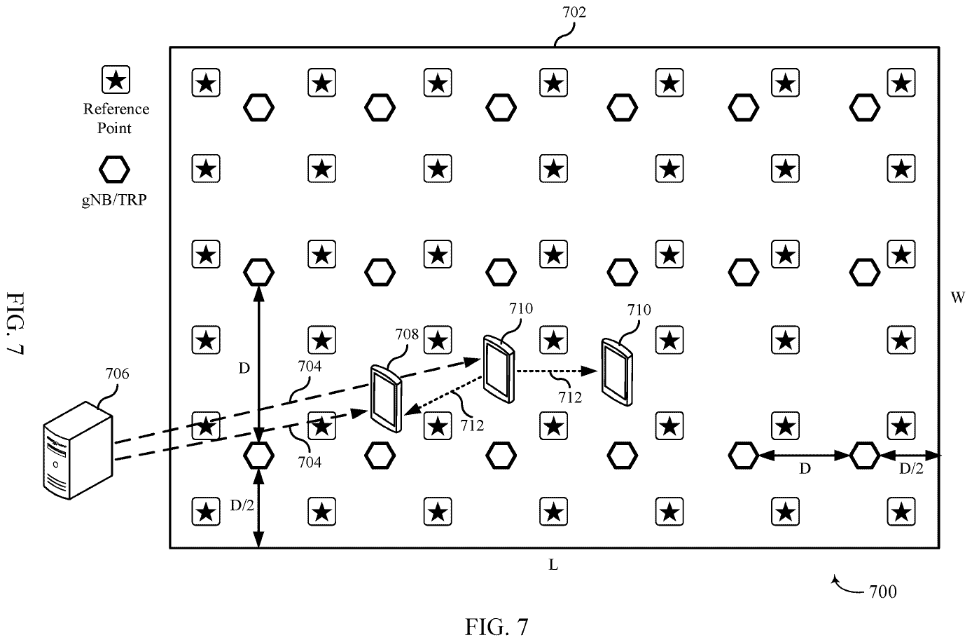

FIG. 7 illustrates an example scenario 700 that supports machine learning for positioning in accordance with aspects of the present disclosure. The scenario 700, for instance, includes representations of the DL and SL direct AI/ML configuration mechanisms, such as discussed above, within a rectangular environment 702 (e.g., an indoor factory hall environment) with length L and width W including reference points and 18 gNB/TRPs separated by an inter-gNB/TRP distance D.

In the scenario 700 DL LTE Positioning protocol (LPP) signaling 704 from a location server 706 to a target UE 708 and/or an anchor/PRU UE 710 may be utilized to convey the plurality Direct AI/ML positioning configurations, e.g., using the LPP Provide AssistanceData message or a new LPP ProvideMLAssistanceData message, while Sidelink Positioning Protocol (SLPP) or new positioning protocol related to the exchange of SL positioning messages may be used for signaling 712 to provide the plurality of direct AI/ML positioning configurations from the anchor/PRU UE 710, e.g., using the SLPP ProvideAssistanceData message. Alternatively or additionally, an SL Positioning Server UE may provide the direct AI/ML positioning configurations via SLPP or the like. Further, the target UE 708 may configure surrounding UEs, PRU UEs, and/or SL positioning server UEs to perform direct AI/ML positioning measurements, e.g., fingerprinting based on reference locations/points. For the purposes of illustration, direct signaling is shown from the location server 706. However, such signaling may be transparently routed via a serving gNB to a UE.

In implementations, an anchor/PRU UE 710 may configure other anchor/PRU UEs 710 to perform AI/ML positioning measurements. Further, an LMF may configure a first set of anchor/PRU UEs 710 to transmit SL PRS to a second set of anchor/PRU UEs 710.

In implementations such as illustrated in the scenario 700, the target UE 708, the anchor/PRU UEs 710, and/or the location server 706 may request a plurality of DL or SL direct AI/ML positioning assistance data, e.g., using the LPP RequestAssistanceData message. Alternatively or additionally, the target UE 708 may request a plurality of SL direct AI/ML positioning assistance data from an anchor/PRU UE 710 and/or a SL positioning server UE, such as using SLPP and/or the SL positioning protocol message RequestAssistanceData.

In implementations that include NG-RAN-assisted positioning, a location server may request a plurality of training datasets based on UL reference signals (e.g., SRS for positioning) from various data sources including neighboring gNBs, TRPs, NG-RAN nodes, PRU TRPs, CUs, DUs, and/or combinations thereof. The training datasets may include reference points and/or reference locations corresponding to an NG-RAN node, CU locations, and/or DU locations, and fingerprint information can be sampled, measured, and/or associated. In implementations, various network entities and/or nodes may be with the following procedures:
An NG-RAN node including gNB and/or TRP may transmit a UL AI/ML direct positioning configuration (e.g., fingerprinting) to one or more UEs upon request from a location server.
UEs including a target UE may receive a response and/or configuration for UL AI/ML direct positioning configuration (e.g., fingerprinting) with respect to a location server.
A location server may transmit a UL AI/ML direct positioning assistance, e.g., fingerprinting data request to one or more NG-RAN nodes including gNB, TRP, CUs, DUs, PRU, and/or combinations thereof, and then receive a configuration response.

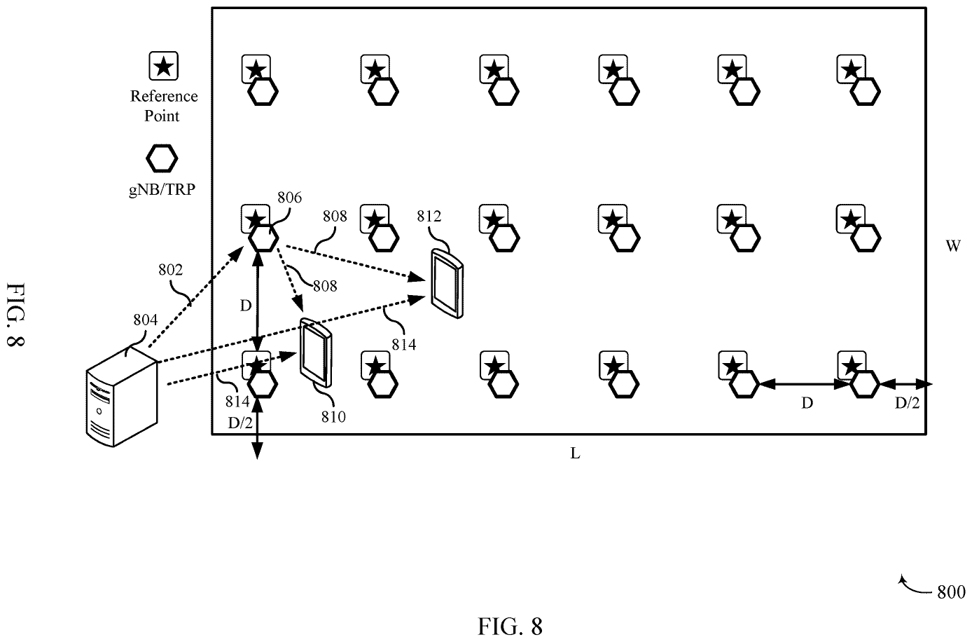

FIG. 8 illustrates an example scenario 800 that supports machine learning for positioning in accordance with aspects of the present disclosure. In the scenario 800, at step 802 a location server 804 triggers a configuration request to an NG-RAN node 806, e.g., a serving gNB and/or neighboring gNBs. Step 806, for instance, involves NRPPa with UL direct AI/ML positioning configuration, e.g., fingerprinting of N reference locations.

At step 808 the NG-RAN node 806 forwards a UL-RS configuration (e.g., SRS for positioning configuration) to a target UE 810 and/or PRU/anchor UE 812 such as to enable performing a UL transmission and a subsequent UL direct AI/ML measurement at a gNB/TRP. Step 808, for instance, may involve RRC with UL direct AI/ML positioning configuration, e.g., fingerprinting of N reference locations.

In implementations, the location server 804 may directly forward an UL-RS configuration via DL LPP signaling for performing a UL transmission and a subsequent UL direct AI/ML measurement at the NG-RAN node 806, e.g., a gNB/TRP. In an alternative implementation, the NG-RAN node 806 may be implemented as a CU and DU, where the location server 804 may signal the CU and the DU may perform UL-RS measurements at different distributed reference locations and/or points, e.g., in an indoor factory scenario such as described above. For instance, at step 814 the location server 804 can transmit UL direct AI/ML positioning configuration, e.g., fingerprinting of N reference locations.

In implementations, the PRU/anchor UE 812 location can be utilized along with a gNB/TRP ground truth reference location to construct a fingerprint including ground truth reference location. In such implementations, the PRU/anchor UE 812 can signal a 2D and/or 3D location at which the SRS is being transmitted towards the configuration entity, e.g., the NG-RAN node 806 and/or the location server 804. In scenarios that include signaling location information towards the location server 804, LPP signaling (e.g., ProvideLocationInformation message) may be used and/or scenarios that involve signaling location information to the NG-RAN node 806, RRC signaling may be used, e.g., LocationMeasurementIndication.

Alternatively or additionally, the configuration entity may request the PRU/anchor UE 812 to transmit UL SRS or SL PRS at certain pre-defined locations. These pre-defined locations may be included within the direct AI/ML configurations along with positioning reference signal configurations.

In implementations, a type of NG-RAN node (e.g., PRU gNB/TRP) may also transmit SRS to other NG-RAN nodes, UEs, and/or devices. The NG-RAN nodes receiving the SRS may perform direct AI/ML positioning measurements for the purposes of direct AI/ML position estimation. Thus, NG-RAN nodes which are capable of transmitting and receiving SRS such as a PRU TRP can support this type of measurements. In implementations, a new reference signal may also be supported between NG-RAN nodes for the purposes of direct AI/ML position estimation and may be transmitted, such as via Xn interface and/or via another wireless transmission medium. In implementations, the configuration methods discussed above can be combined, such as to enable utilization of DL, SL, and/or UL direct AI/ML positioning measurements individually and in combination.

In implementations, configurations such as signaled as described above may be used to enable direct AI/ML position estimation, e.g., using fingerprinting methods. Configuration content, for instance, is considered according to the above described implementations and as discussed below.

In scenarios for UE-based positioning, such as with a UE-sided model, a target UE may create a plurality of fingerprint training datasets based on performed measurements, data, received measurements, and/or data from other network entities, e.g., location servers, other UEs, PRUs, and so forth. The target UE may initiate a request towards the location server for configurations related to the measurements of DL or SL direct AI/ML measurements (e.g., fingerprint measurements) and/or request the transmission configuration of UL-RS related to direct AI/ML positioning. An example configuration is discussed below.

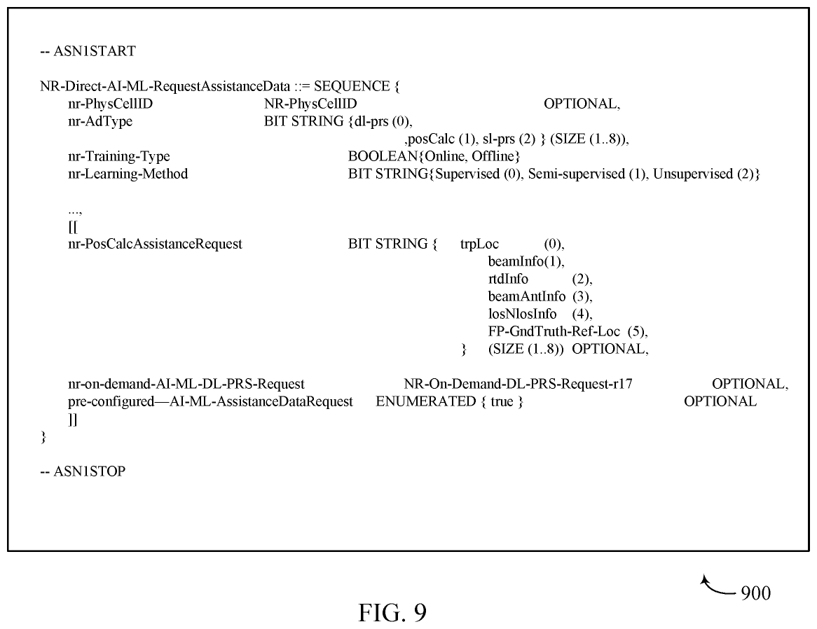

FIG. 9 illustrates a message 900 that supports machine learning for positioning in accordance with aspects of the present disclosure. The message 900, for example, represents a NR-Direct-AI-ML-AssistanceData information element that can be used by a target device to request direct AI/ML positioning assistance data from a location server and/or a configuration entity, e.g., SL positioning server UE, anchor UE, etc.

Table 5 below provides example field descriptions for the message 900.

TABLE 5
NR-Direct-AI-ML-RequestAssistanceData field descriptions

nr-PhysCellID
This field specifies the NR physical cell identity of the current primary cell of the target device.
nr-AdType
This field indicates the requested assistance data or DL positioning configuration. dl-prs refers to
the requested DL-PRS configuration for Direct AI/ML measurement, posCalc means requested
assistance data is nr-PositionCalculationAssistance for UE based positioning,
nr-Training-Type
This field indicates whether the requested Direct AI/ML configuration is utilized for
online/offline training.
nr-on-demand-DL-PRS-Request
This field indicates the on-demand DL-PRS requested for Direct AI/ML positioning. In one
implementation, this may be applicable to UE-initiated on-demand PRS. This field may be
included when the dl-prs or sl-prs bit in nr-AdType is set to value ‘1’ or ‘2’.
nr-Learning-Method
This field indicates the type of learning method employed for the requested assistance data. This
is represented by a bit string, with a one value at the bit position means the particular assistance
data is requested; a zero value means not requested.
bit 0 indicates whether Supervised learning model(s) are employed at the target device
bit 1 indicates whether Semi-supervised learning model(s) are employed at the target device
bit 2 indicates whether Unsupervised learning model(s) are employed at the target device
NR-Direct-AI-ML-RequestAssistanceData field descriptions
nr-PosCalcAssistanceRequest
This field indicates the Position Calculation Assistance Data requested for performing Direct
AI/ML positioning. This is represented by a bit string, with a one-value at the bit position means
the particular assistance data is requested; a zero-value means not requested.
bit 0 indicates whether the field nr-TRP-LocationInfo in information element (IE) NR-
PositionCalculationAssistance is requested or not;
bit 1 indicates whether the field nr-DL-PRS-BeamInfo in IE NR-
PositionCalculationAssistance is requested or not;
bit 2 indicates whether the field nr-RTD-Info in IE NR-PositionCalculationAssistance
is requested or not;
bit 3 indicates whether the field nr-TRP-BeamAntennaInfo in IE NR-
PositionCalculationAssistance is requested or not;
bit 4 indicates whether the field nr-DL-PRS-Expected-LOS-NLOS-Assistance in IE
NR-PositionCalculationAssistance is requested or not.
bit 5 indicates whether the fingerprint ground truth reference points/locations are requested or
not
This field may only be present if the ‘posCalc’ bit in nr-AdType is set to value ‘1’.
pre-configured-AI-ML-AssistanceDataRequest
This field, if present, indicates that the target device requests pre-configured assistance data for
Direct AI/ML positioning with area validity.

In implementations, the message 900 can include direct AI/ML positioning assistance data, assisted AI/ML positioning, or a combination thereof. Assisted AI/ML positioning measurements may be defined as measurements, which have been enhanced and/or optimized using AI/ML models, e.g., RAT-dependent measurements such as RSTD, relative time of arrival (RTOA), RSRP, RSRPP, Rx-Tx, AoAs, AoDs, time difference and so forth.

In implementations, in relation to UE-based positioning such as described above, a target UE can provide an index or list of ground truth reference locations, e.g., absolute and/or relative locations. Example ground truth reference locations are defined below.

In implementations such as that involve UE-based positioning (e.g., with a UE-sided model and/or UE-assisted positioning with LMF-sided model), a location server may transmit direct AI/ML positioning assistance data. Alternatively or additionally, the location server may transmit assisted AI/ML positioning assistance data to one or more target devices, PRU UEs, anchor UEs, SL positioning server UEs, etc., for performing direct AI/ML and/or assisted AI/ML measurements to be used as training data input. A target UE, for instance, may receive from the location server a plurality of configurations related to the measurements of DL or SL Direct AI/ML measurements, e.g., fingerprint measurements and/or transmission configuration of UL-RS related to direct AI/ML positioning.

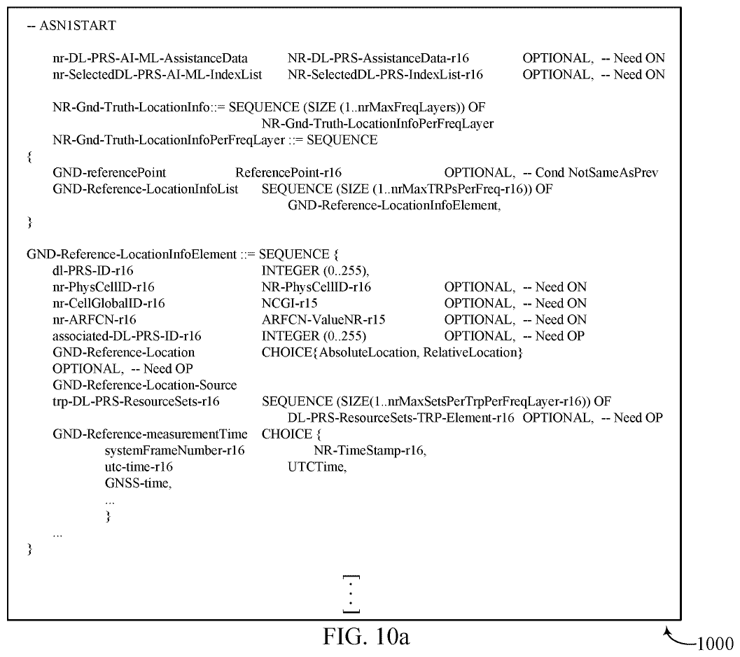

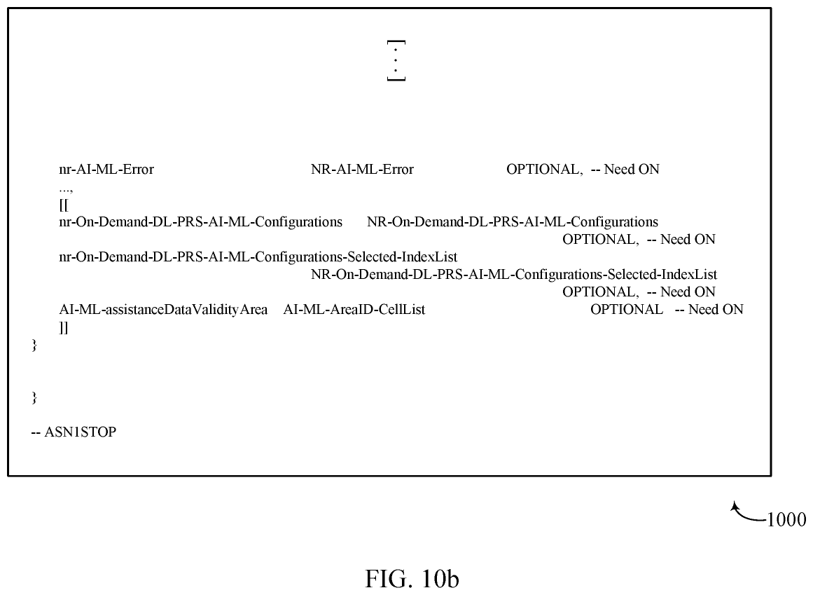

FIGS. 10a and 10b illustrate different portions of a message 1000 that supports machine learning for positioning in accordance with aspects of the present disclosure. The message 1000, for instance, represents a NR-Direct-AI-ML-ProvideAssistanceData message.

Table 6 below provides example field descriptions for the message 1000.

TABLE 6
NR-Direct-AI-ML-ProvideAssistanceData field descriptions

dl-PRS-ID or sl-PRS-ID
This field is used along with a DL-PRS Resource Set ID and a DL-PRS Resources ID or a SL-
PRS Resource Set ID and a SL-PRS Resources ID to uniquely identify a DL-PRS Resource or
SL-PRS Resource. This ID can be associated with multiple DL-PRS Resource Sets associated
with a single TRP or multiple SL-PRS Resource Sets associated with a single SL transmission
point.
Each TRP or SL transmission point should only be associated with one such ID.
nr-PhysCellID
This field specifies the physical cell identity of the associated TRP
nr-CellGlobalID
This field specifies the NR Cell Global Identifier (NCGI), the globally unique identity of a cell in
NR, of the associated TRP]. The server should include this field if it considers that it is needed to
resolve ambiguity in the TRP indicated by nr-PhysCellID.
nr-ARFCN
This field specifies the NR- Absolute Radio Frequency Channel Number (ARFCN) of the TRP's
CD-SSB (Cell-defining SSB) corresponding to nr-PhysCellID.
associated-DL-PRS-ID
This field specifies the dl-PRS-ID of the associated TRP from which the beam information is
obtained.
GND-referencePoint
This field specifies a configured ground truth reference point used to define the ground truth
location in the GND-Reference-LocationInfoList.
GND-Reference-LocationInfoList
This field provides an index or list of Ground truth reference point locations for performing the
AI/ML DL or SL positioning measurements, which based on reception and measurement of DL-
PRS or SL-PRS resources.
GND-Reference-Location
This field provides Ground truth reference locations for performing the AI/ML DL or SL
positioning measurements, e.g., fingerprinting, which based on reception and measurement of
DL-PRS or SL-PRS resources. These can be represented by an absolute location or relative
location to the GND-referencePoint or another UE/device. The absolute/relative location may be
determined by offline position determination or a location estimate defined by using one of the
geographic shapes defined in TS23.032. This can be based on RAT-dependent, e.g., DL-TDOA,
Multi-RTT, DL-AoD, etc. or RAT-independent, e.g., GNSS coordinates, Bluetooth, WiFi, etc.
location determination. This may comprise of 2D or 3D location estimates.
GND-Reference-Location-Source
Provides the source positioning technology used to determine the location estimate or value of the
ground truth reference location or point.
GND-Reference-measurementTime
This field provides the time for which the ground truth reference location or point is valid to
perform Direct AI/ML measurements. The time formats may be represented in terms of the
System Frame Number (SFN), UTC time, GNSS time and so forth. In other implementations, this
time may be associated with the validity to perform Assisted AI/ML measurements. In an
alternative implementation, this may also be represented as a time window.
AI-ML-assistanceData Validity Area
This field provides the geo-spatial criteria for which the AI/ML positioning configuration is to be
valid. This may comprise of a Cell ID, TRP ID, beam ID, an area list, tracking area, RAN
notification area, Zone ID or any one or more combination thereof.

In implementations, DL-PRS configuration information described above can be used to allow a device (e.g., target UE, PRU UE, SL UE, etc.) to perform direct AI/ML measurements at each of configured ground truth reference locations, such as signaled above. This process may be performed during an offline phase, and the measurements and respective locations may be signaled to location server or stored within a single UE or multiple UEs.

In implementations that involve NG-RAN assisted positioning (e.g., with LMF-sided model) a location server may transmit one or more requests for a plurality of direct AI/ML positioning assistance data in terms of available SRS and/or other UL-PRS configurations to multiple gNBs and/or TRPs. One or more gNBs and/or TRPs may determine the SRS configuration per target UE for performing SRS transmission related AI/ML positioning, which may be configured per carrier. In implementations, the SRS configuration may be broadcast to multiple UEs for use in multiple cells, within a predefined positioning system information area, within an area with an associated validity in terms of time and/or area, and combinations thereof.

In implementations a gNB and/or TRP may configure a UE to perform SRS for positioning transmissions via RRC signaling using, e.g., RRCReconfiguration message. The gNB and/or TRP may configure the UE to perform SRS for positioning transmissions in order to perform direct AI/ML positioning or assisted AI/ML positioning.

In implementations a target UE may confirm reception of SRS for positioning configuration to perform direct AI/ML positioning and/or assisted AI/ML positioning measurements along with other non-AI/ML timing or angle-based measurements. A location server (e.g., LMF) may request one or more gNBs and/or TRPs to activate the SRS for positioning configuration for transmission by the target UE. The gNB and/or TRP may activate the transmission of SRS to a UE by transmitting a DL MAC control element (CE) activation command to the target UE. The location server may further deactivate the SRS transmission via the gNB, and the gNB can transmit a deactivation command using, e.g., a DL MAC CE.

In implementations a location server may receive a plurality of available SRS or UL-PRS configurations for performing UL Direct AI/ML positioning. In an example scenario, a gNB can derive SRS and/or UL-PRS fingerprints for location estimates for multiple UEs.

In implementations, lower layer signaling with respect to LPP (e.g., RRC signaling, MAC CE, downlink control information (DCI) signaling, and combinations thereof) may be used to convey direct AI/ML or assisted AI/ML configurations. In at least one implementation, LPP and/or RRC signaling may be used to add, modify, remove, update, activate, and/or deactivate one or more UE direct AI/ML positioning configuration.

Implementations enable direct AI/ML measurement and processing procedures. For instance, methods to perform direct AI/ML measurements are presented based on a type of AI/ML approach. In at least one implementation the fingerprint measurements may rely on Received Signal Strength (RSS) measurements including RSRP, Reference Signal Received Quality (RSRQ), RSSI, or combinations thereof. In implementations, the fingerprint measurements may include a combination of RSS, timing-based, and angular-based measurements to learn a UE's location estimate.

In implementations, a target UE, PRU UE, SL UE, etc., may be configured to measure the following measurements to construct an RF fingerprint applicable to:
RAT-dependent Measurements:
   DL/SL RSTD (DL-based or SL-based measurements)
   DL/SL PRS Time Of Arrival (TOA) (DL-based or SL-based measurements)·
   DL/SL PRS RSRP (DL-based or SL-based measurements)
   DL/SL PRS RSRPP (DL-based or SL-based measurements)
   UE Rx-Tx time difference (DL-based or SL-based measurements)
   Synchronization Signal (SS)-RSRP (RSRP for RRM), SS-RSRQ (for RRM), CSI-RSRP (for RRM), CSI-RSRQ (for RRM), SS-RSRP (for RRM) (DL-based measurements)
   DL/SL Carrier phase measurements (DL-based or SL-based measurements)
   DL/SL Carrier phase difference measurements (DL-based or SL-based measurements)
   DL E-CID
   LTE E-CID
   SL physical sidelink shared channel (PSSCH) RSRP,
   DL PRS RSSI (Received Signal Strength Indicator)
   LTE Observed Time Difference of Arrival (OTDOA) measurements
RAT-independent Measurements
   A-GNSS measurements including common assistance data, which may be applicable to any GNSS constellation, e.g., Galileo, GPS, GLONASS, etc., generic assistance data for a specific GNSS constellations or periodic GNSS assistance data that is used to provide GNSS control information on a periodic basis to the UE/device.
   Bluetooth RSS measurements including RSSI
   WLAN (WiFi) measurements including RSSI and RTT information
   IMU Sensor measurements including gyroscope, accelerometer and so forth.
   Barometric sensor measurements

In implementations, a NG-RAN node, gNB/TRP, CU-DU, etc., may be configured to measure the following measurements applicable to:
RAT-dependent Measurements
   UL-RTOA (UL-based measurement)
   UL SRS RSRP (UL-based measurement)
   UL SRS RSRPP (UL-based measurement)
   gNB Rx-Tx time difference measurements (UL-based measurement)
   UL-AoA (UL-based measurement)
   UL Carrier phase measurements (UL-based measurements)
   UL Carrier phase difference measurements (UL-based measurements)
   UL NR E-CID
   LTE E-CID

Instances of the above measurements may constitute a plurality of fingerprint measurements including part of a DL or UL direct AI/ML positioning measurement at one or more ground truth locations. The use of RAT-dependent and RAT-independent methods may assist in deriving hybrid fingerprints to enhance accuracy of direct AI/ML positioning methods.

In implementations, a location server (e.g., LMF) may provision a direct AI/ML and/or assisted AI/ML configuration for measurement, such as based on a type of AI and/or machine learning model. These models may include the following, and are not limited to any one or more of the following combinations:
Supervised Learning Approaches:
   k-NN (nearest neighbor) clustering
      This model classifies the fingerprints according to the Euclidean distance between neighboring training data points and determines the K-neighbors which have the maximum closeness to the input fingerprints.
   Support Vector Machines (SVM)
      This model is based on margin calculation, wherein the input fingerprint data is plotted in n-dimensional space with n−1 hyper-plane drawn in order to divide the training data in n classes such that distance between each class and the hyper-plane is maximized.
   Decision tree
      The classification or regression problem with regard to Fingerprint matching may be solved using a decision tree like structure. Rules are used to split the training data into multiple labels, wherein the labels are predicted for any new fingerprint data points through this decision tree.
   Random Forest
      This model is a collection of a number of decision trees wherein the outcome of each tree provides a fingerprint classification or in another implementation the mean prediction of all decision trees is in the output. This assists in overcoming the overfitting problem experienced by standalone decision trees.
   Artificial Neural Networks (ANNs)
      Based on back propagation learning algorithms, an input dataset of fingerprint data is transformed using non-linear transfer function within intermediate units/nodes that comprise of a hidden layer, into an output of final location estimates. Such models can be robust against noisy or interference limited fingerprint data.
Unsupervised Approaches:
   K-means
      This model partitions the fingerprints into K number of unique and non-overlapping cluster or groups to characterize specific location points.
   Gaussian Mixture Models (GMM)
      GMM is a probabilistic model that can be used to estimate the distribution of RF fingerprints in different locations including ground truth reference locations as well as unknown locations. The GMM can be trained using the collected RF fingerprints and can then be used to determine the most likely location for a given set of RF fingerprints.
Both Supervised and Unsupervised Approaches:
   Bayesian Networks (BN)
      BNs can be used to model the probabilistic relationships between RF fingerprints, environmental factors such as radio channel parameters, e.g., channel state information (CSI), pathloss, fading parameters, for a given location. BNs can be trained using a BN configured training set of RF fingerprints and environmental data to perform RF fingerprint localization.
Learning
   Reinforcement Learning
      A learning algorithm based on trial-and-error methods, whereby decisions are based on so-called “rewards” or “punishments”, in which correct decisions are awarded while incorrect decisions are penalized to enhance model performance.
   Deep Learning
      Based on ANNs, which employ iterative weight adjusting techniques among pair of neurons/nodes, which are trained with large sets of fingerprint data collected from the environment.
   Transfer Learning
      Leverages the model's ability to learn new features and subjects against its own system knowledge, which allows minimal changes to a an already existing trained model. This may be leverage Direct AI/ML positioning, e.g., fingerprinting to provide a scalable solution in order to avoid the large overhead of collecting on-site fingerprints during the initial site survey, e.g., during the offline phase.

In implementations a location server may explicitly indicate ML models to a target UE and/or PRU UE using UE-specific LPP/SLPP signaling, e.g., SLPP/LPP Provide AssistanceData messages. In implementations, the models may be indicated using positioning system information broadcast messages, e.g., new and/or existing posSIBs to multiple UEs.

In implementations, a location server and/or configuration entity may receive a request from a target UE, PRU UE, and/or SL UE for direct AI/ML positioning or assisted AI/ML positioning assistance data along with an indication of the aforementioned described models for which the measurements are to be used as input data.

In implementations, the ML models used to initiate a direct AI/ML or assisted AI/ML positioning session may be indicated via applicable UE capability signaling (e.g., LPP ProvideCapabilites message) which may be based on a solicited request from the location server and/or configuration entity, e.g., a LPP RequestCapabilities message.

In implementations, a PRS RSSI measurement can be defined for purposes of AI/ML positioning including both direct and assisted techniques. In implementations, the PRS RSSI can be applicable to non-AI/ML positioning techniques. Further, these measurements may be performed in RRC_CONNECTED, RRC_INACTIVE, and RRC_IDLE states. The PRS RSSI for downlink, sidelink and uplink can be defined as follows in Table 7.

TABLE 7
DL, SL and UL PRS RSSI measurement definitions
DL PRS RSSI (Received Signal Strength Indicator)

| | |
|---|---|
| Definition | DL PRS reference signal received path power (DL PRS-RSRPP), is defined as |
| | the linear average of the total received power (in [W]) observed in resource |
| | elements of a slot that carry DL PRS signal configured for the measurement. In |
| | other implementations, the power unit may include dBm or dB. |
| | For frequency range 1, the reference point for the DL PRS-RSSI shall be the |
| | antenna connector of the UE. For frequency range 2, DL PRS-RSSI shall be |
| | measured based on the combined signal from antenna elements corresponding |
| | to a given receiver branch. |
| Applicable for | RRC_CONNECTED, |
| | RRC_INACTIVE, |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |

SL PRS RSSI (Received Signal Strength Indicator)

| | |
|---|---|
| Definition | Sidelink PRS Received Signal Strength Indicator (SL PRS RSSI) is defined as |
| | the linear average of the total received power (in [W]) observed in the |
| | configured sub-channel in OFDM symbols of a slot configured for physical |
| | sidelink control channel (PSCCH) and PSSCH carrying SL PRS symbols, |
| | starting from the 2^{nd} OFDM symbol. In other implementations, the power unit |
| | may include dBm or dB. |
| | For frequency range 1, the reference point for the SL PRS RSSI shall be the |
| | antenna connector of the UE. For frequency range 2, SL PRS RSSI shall be |
| | measured based on the combined signal from antenna elements corresponding |
| | to a given receiver branch. For frequency range 1 and 2, if receiver diversity is |
| | in use by the UE, the reported SL PRS RSSI value shall not be lower than the |
| | corresponding SL PRS RSSI of any of the individual receiver branches. |
| Applicable for | RRC_CONNECTED, |
| | RRC_INACTIVE, |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |
| | NOTE: Currently no states are defined for SL communication and positioning, |
| | however this applicability would extend to any future support of the above |
| | operational states for SL communication and positioning. |

UL SRS RSSI (Received Signal Strength Indicator)

| | |
|---|---|
| Definition | UL SRS reference signal received power (UL SRS-RSRP) is defined as linear |
| | average of the total received power (in [W]) observed in resource elements of a |
| | slot carrying sounding reference signals (SRS). In other implementations, the |
| | power unit may include dBm or dB. UL SRS RSSI shall be measured over the |
| | configured resource elements within a slot of the considered measurement |
| | frequency bandwidth in the configured measurement time occasions. In other |
| | implementations, the power unit may include dBm or dB. |
| Applicable for | RRC_CONNECTED, |
| | RRC_INACTIVE, |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |

In implementations and according to the measurement definitions presented in Table 7, DL, SL, and UL PRS RSSI may include a feature or signature of a fingerprint which can be used to enable direct AI/ML positioning. Further, a PRS or SRS TOA measurement may be further defined to act as a further feature or signature for the purposes of AI/ML positioning including both direct and assisted techniques. In implementations, the PRS TOA can be applicable to non-AI/ML positioning techniques. Further, these measurements may be performed in RRC_CONNECTED, RRC_INACTIVE, and RRC_IDLE states. The PRS TOA for downlink, sidelink and uplink (SRS) are defined as follows in Table 8.

TABLE 8
DL, SL and UL PRS TOA measurement definitions
DL PRS TOA (Time of Arrival)

| | |
|---|---|
| Definition | The DL PRS Time of Arrival is the measured time-of-arrival of the start of the |
| | subframe containing SL PRS received in Reception Point (RP) j. It can be |
| | further defined as the reception time of the DL PRS at the receiver reference |
| | point. In one implementation, the reference point shall be the antenna connector |
| | of the UE/device. |
| | Multiple DL PRS resources can be used to determine the beginning of one |
| | subframe containing DL PRS received at a RP. |
| Applicable for | RRC_CONNECTED, |
| | RRC_INACTIVE, |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |

SL PRS TOA (Time of Arrival)

| | |
|---|---|
| Definition | The SL PRS Time of Arrival is the measured time-of-arrival of the start of the |
| | subframe containing SL PRS received in Reception Point (RP) j. It can be |
| | further defined as the reception time of the SL PRS at the receiver reference |
| | point. In one implementation, the reference point shall be the antenna connector |
| | of the UE/device. |
| | Multiple SL PRS resources can be used to determine the beginning of one |
| | subframe containing SL PRS received at a RP. |
| Applicable for | RRC_CONNECTED, |
| | RRC_INACTIVE |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |
| | NOTE: Currently no states are defined for SL communication and positioning, |
| | however this applicability would extend to any future support of the above |
| | operational states for SL communication and positioning. |

UL SRS TOA (Time of Arrival)

| | |
|---|---|
| Definition | The UL SRS Time of Arrival is the measured time-of-arrival of the start of the |
| | subframe containing SRS received in Reception Point (RP) j. It can be further |
| | defined as the reception time of the UL SRS at the receiver reference point. In |
| | one implementation, the reference point shall be the receiver antenna connector |
| | of the base station, while in another implementation the reference point may the |
| | center location of the radiating region of the receiver antenna of the base station. |
| | In yet another implementation the reference point may include the receiver |
| | transceiver boundary array connector of a base station. |
| | Multiple SRS resources can be used to determine the beginning of one subframe |
| | containing SRS received at a RP. |
| Applicable for | RRC_CONNECTED, |
| | RRC_INACTIVE, |
| | RRC_IDLE |
| | The above includes various operational states, which refer to the state of a User |
| | Equipment (UE) in terms of the radio connection with the LTE/5G network. |
| | The RRC state of a UE is determined by the network based on the UE's/device's |
| | activity including any power/energy requirements and the network's |
| | requirements for radio resources. The UE transitions between the different RRC |
| | states in response to network commands or as a result of changing network |
| | conditions. Therefore, this measurement may be supported in the above |
| | mentioned operational states. |

In implementations, a target UE and/or PRU UE may be configured to measure DL PRS and/or SL PRS for AI/ML positioning, such as in one or more of the following scenarios:
Configured with a Measurement Gap (MG) associated with Gap pattern ID, Measurement Gap Length (MGL) and Measurement Gap Repetition Period (MGRP) or combination thereof. This MG may be pre-configured with an activation or deactivation command.
Configured without or outside a measurement gap, in the case the DL PRS is within an active DL bandwidth part (BWP) with the same numerology as active DL BWP.
Configured training measurement gap (T-MG), with a pre-defined with Gap pattern ID, Measurement Gap Length (MGL) and Measurement Gap Repetition Period (T-MGRP), T-MG start time, T-MG duration, T-MG End time, flag indicating if the measurements are either based for offline-training or online-training or combination thereof. In other implementations, a duration of time given by measurement window or timer expiry may be used to indicate the start and end of a duration to perform measurements for online or offline training of an AI/ML positioning model.

In implementations, for each received DL/SL PRS, a UE may be configured with a priority configuration of the PRS resources used for performing AI/ML positioning and non-AI/ML positioning measurements. These resources may form a subset of resources, which may form part of the same or different PRS resource set. This priority signaled to the UE/devices can indicate the priority of performing measurements, which can construct a training dataset additionally or alternatively to performing measurements for non-AI/ML positioning.

Implementations also provide for providing assistance data and/or measurement error causes. For instance, a UE may indicate to a network and/or configuration entity that one or more measurements associated to a ground truth location and/or fingerprint has as an associated error cause. The error cause being, for example, not receiving PRS configuration or the PRS configuration is missing configuration parameters. For instance, utilizing implementations described above, LPP and/or SLPP signaling may be used to indicate error causes to the network. Further, error causes may be UE-initiated, e.g., such as originating at the UE side. In implementations, error causes may be a location server-initiated indication to the UE.

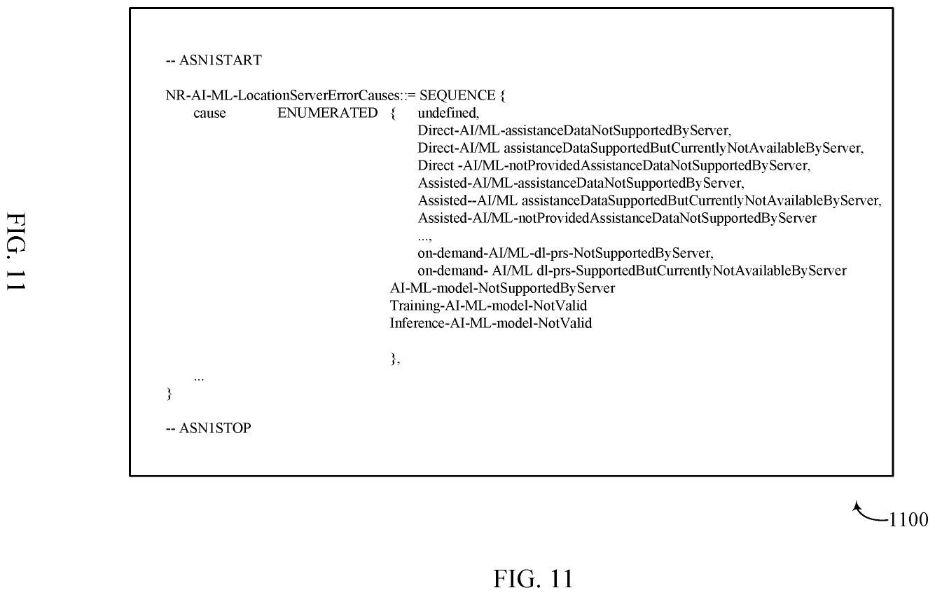

FIG. 11 illustrates a message 1100 that supports machine learning for positioning in accordance with aspects of the present disclosure. The message 1100, for instance, represents an IE that shows supported error causes by the location server and/or configuration entity, such as which can be conveyed via LPP. For example, the message 1100 represents an NR-AI-ML-LocationServerErrorCauses IE that can be used by a location server to provide AI/ML assistance data error reasons to a target device. The message 1100 can also be used for SL configuration entities providing such error causes to a target UE and/or device.

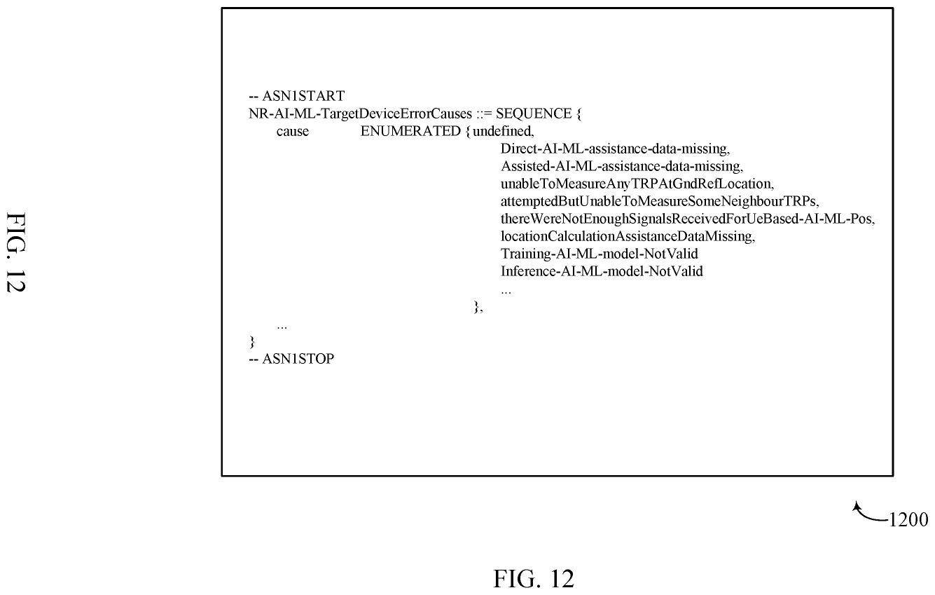

FIG. 12 illustrates a message 1200 that supports machine learning for positioning in accordance with aspects of the present disclosure. The message 1200, for instance, presents supported error causes by a target UE, which can be conveyed via LPP. The message 1200, for instance, represents a NR-AI-ML-TargetDeviceErrorCauses IE which can be used by the target UE to provide NR direct AI/ML or assisted AI/ML measurement error reasons to a location server. Such implementations may be applicable to the SL target UE and/or device providing the above error causes to the SL configuration entities.

In implementations, an NG-RAN node may signal an IE NR-AI-ML-NG-RANnodeErrorCauses, with one or more combinations of parameters included in the above described NR-AI-ML-TargetDeviceErrorCauses IE. Error causes derived at the NG-RAN node (e.g., gNB and/or TRP) may be signaled to a location server via an NRPPa interface, e.g., using the Error Indication message. Additionally, the following error causes may be signaled from the NG-RAN node side:
The target UE or PRU UE has moved to another cell.
The requested AI/ML positioning measurement could not be provided on time.
AI/ML training model is not valid and needs to be re-trained.
AI/ML inference model is not valid and needs to be re-acquired.

In implementations, positioning measurements including the definitions contained in Table 7 and Table 8 may have an associated quality indicator indicating the following:
Quality of the performed measurement based on timing and RSS parameters.
Quality of the performed measurement with respect to the similar measurements performed in the surrounding ground truth reference locations.

Implementations described herein also provide for reporting configuration procedures. For instance, implementations enabling reporting configuration of direct AI/ML positioning measurements and reporting (e.g., fingerprints) are described such as for the following scenarios, where an inference AI/ML model may be deployed at the following entities to perform positioning:
UE-based positioning with UE-side model
UE-assisted/LMF-based positioning with LMF-side model
NG-RAN node assisted positioning with LMF-side model

The scenarios above are presented as examples only and the corresponding details are extendable beyond these example scenarios.

In scenarios for UE-based positioning, a target UE may request training datasets based on DL and SL reference signals (e.g., DL-PRS, SL-PRS, etc.) from various data sources including measurements performed and collected internally within the target UE, at other UEs, at a location server, at an NG-RAN node, at a PRU, at OAM, at TCE, and/or combinations thereof. Further, training can be performed at the UE-side and a computed location estimate may be computed by the target UE device. In such implementations, a reporting configuration including reporting criteria and/or assistance information and associated measurement reporting may be initiated from the target UE.

Various network entities, UEs, and/or nodes may be enabled with the following procedures to enable a reporting configuration, such in scenarios where AI/ML model training is performed at the UE-side.

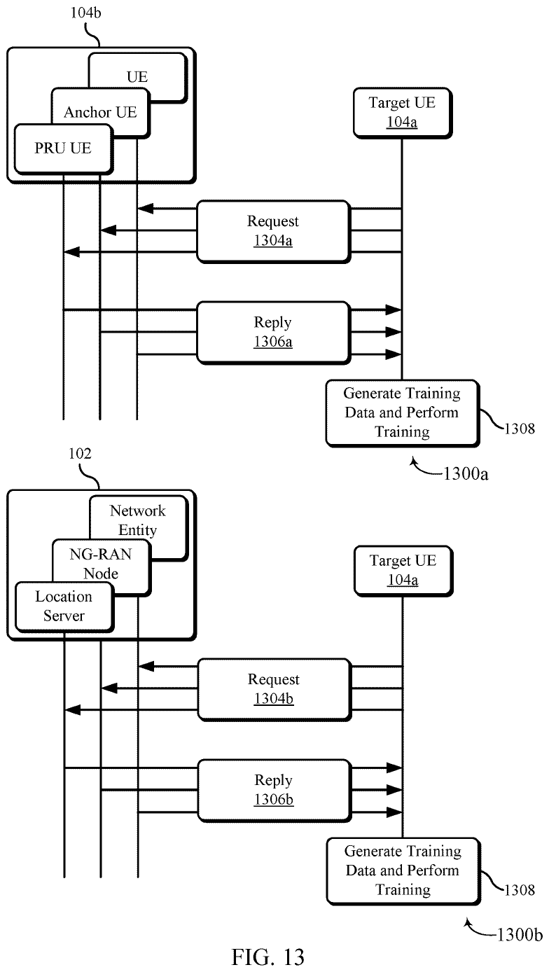

FIG. 13 illustrates scenarios 1300 that support machine learning for positioning in accordance with aspects of the present disclosure. The scenarios 1300, for instance, include a scenario 1300a wherein UE-side training can be performed with target UE inference with other UEs, and a scenario 1300b where UE-side training can be performed with target UE inference with network entities.

In the scenarios 1300, at 1302 a target UE 1304 may request a plurality of direct AI/ML positioning measurements based on defined reporting criteria. For instance, in the scenario 1300a for signaling transport towards a UE, at 1304a the SL positioning protocol (SLPP) and/or other defined positioning protocol may be employed by a target UE 104a for requesting from UEs 104b direct AI/ML positioning reports including measurement reporting criteria and/or assistance information. At 1300b and for network entities 102 such as location server, at 1304b LPP signaling may be employed for requesting direct AI/ML positioning reports including measurement reporting criteria and/or assistance information. In scenarios involving an NG-RAN node, RRC and/or related UL signaling such as UL MAC CE may be utilized.

Further to the scenarios 1300, the respective network entities 102 and/or UEs 104 may provide responses 1306 to the requests 1304 to provide measurements correlating to the reporting criteria and/or assistance information indicated in the requests 1304. For instance, the UEs 104b can reply at 1306a via SLPP, and the network entities can reply at 1306b via LPP and/or RRC. In scenarios for network entities 102 reporting measurements, a location server may receive measurement reports from other UEs based on solicited or unsolicited requests (e.g., PRU UEs and/or other UEs) and report such measurements to the target UE 104a.

At 1308 the target UE 104a can construct a training dataset based on measurement reports from different sources and performs training of an AI/ML model. In implementations, the target UE 104a can perform inference utilizing a trained ML model and based on new measurement data by repeating steps 1304a, 1304b and 1306a, 1306b to obtain new measurement data for processing via a trained ML model. In implementations training and inference datasets may be requested in single shot, such as to avoid repeating 1304 and 1306 to training an ML model and then subsequently perform inference.

In implementations, ML model training may be performed at the network-side (e.g., at the location server or NG-RAN node (e.g., gNB)) and/or other UE/device, e.g., anchor UE, PRU UE, SL UE and so forth. In such implementations, the network entity and/or UE/device may request a plurality of reporting criteria such that the desired measurements and assistance information are reported in a timely and accurate manner. These datasets may contain reference points or reference locations, where the fingerprint information or other positioning measurements are sampled or measured or associated.

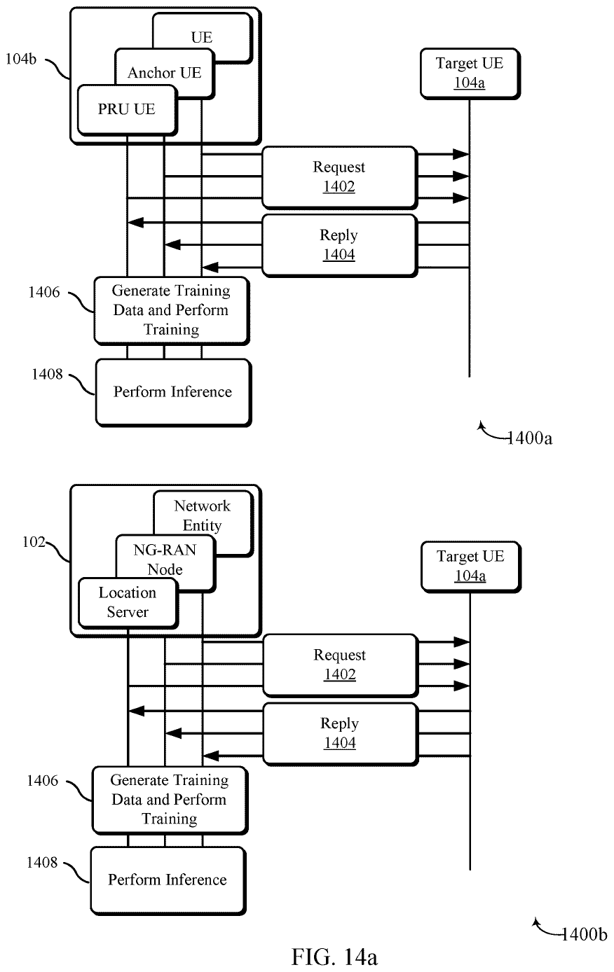

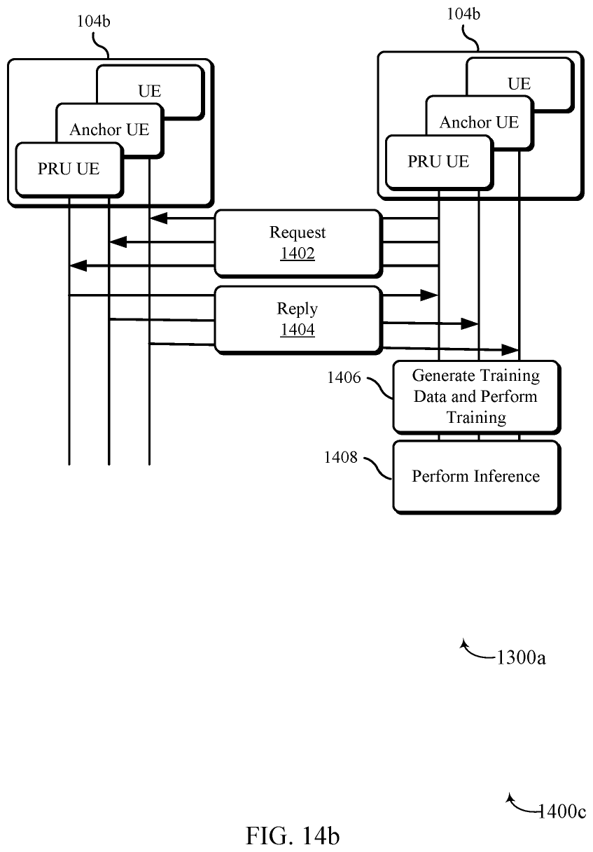

FIGS. 14a and 14b illustrate scenarios 1400 that support machine learning for positioning in accordance with aspects of the present disclosure. The scenarios 1400, for instance, include a scenario 1400a and a scenario 1400c where UE-side training is performed with target UE inference, and a scenario 1400b where network-side training is performed with target UE inference.

In the scenarios 1400, at 1402 the respective network entities 102 and/or UEs 104 may request from the target UE 104a a plurality of direct AI/ML positioning measurements based on certain defined reporting criteria. In terms of signaling transport towards UEs 104, SLPP and/or a newly defined positioning protocol may be employed, while in the case of network entities 102 such as location server, LPP signaling may be employed, and in scenarios for an NG-RAN node, RRC or any related DL signaling such as DL MAC CE may be employed.

At 1404 the target UE 104a may respond to the received requests and provide the requested measurements according to the reporting criteria and/or assistance information. For network entities 102, the location server may for example receive measurement reports from other UEs based on solicited or unsolicited requests (e.g., PRU UEs, other UEs, etc.) and then report such measurements to the target UE 104a.

At 1406 the other respective UEs 104b and/or network entities 102 can generate a training dataset based on measurement reports from different sources and perform training of an AI/ML model.

At 1408 and according to implementations the other respective UEs 104b and/or network entities 102 can perform inference based on new measurement data by repeating the procedures at 1402, 1404. In implementations the training and inference datasets may be requested in single shot, such as alternatively to repeating 1402, 1404.

In implementations the various network entities or nodes may be enabled with the following procedures to enable a reporting configuration in scenarios where the AI/ML model training is not performed at the UE side:
The target UE performing the training may transmit a direct AI/ML positioning reporting configuration towards the network entity and/or other UEs/devices and receive a corresponding report for downlink (DL) or sidelink (SL) Direct AI/ML positioning measurements, e.g., fingerprint measurements. In other implementations UL positioning measurements may also be provided, such as in cases where the UE may train a model based on such UL measurements, e.g., fingerprints.
The network entity (e.g., location server and/or NG-RAN node) performing the training may transmit a direct AI/ML positioning reporting configuration towards the target UE and receive a corresponding report for downlink (DL) or sidelink (SL) Direct AI/ML positioning measurements, e.g., fingerprint measurements.
A UE/node (e.g., anchor UE, PRU UE, SL UE, etc.) performing the training may transmit a direct AI/ML positioning reporting configuration towards the target-UE and receive a corresponding report for downlink (DL) or sidelink (SL) direct AI/ML positioning measurements, e.g., fingerprint measurements.

In scenarios for UE-assisted positioning, a location server may request measurement training datasets based on DL and SL reference signals (e.g., DL-PRS, SL-PRS, etc.) from various data sources including measurements collected internally within the location server, multiple UEs, other neighboring location servers, NG-RAN nodes, positioning reference units, and combinations thereof.

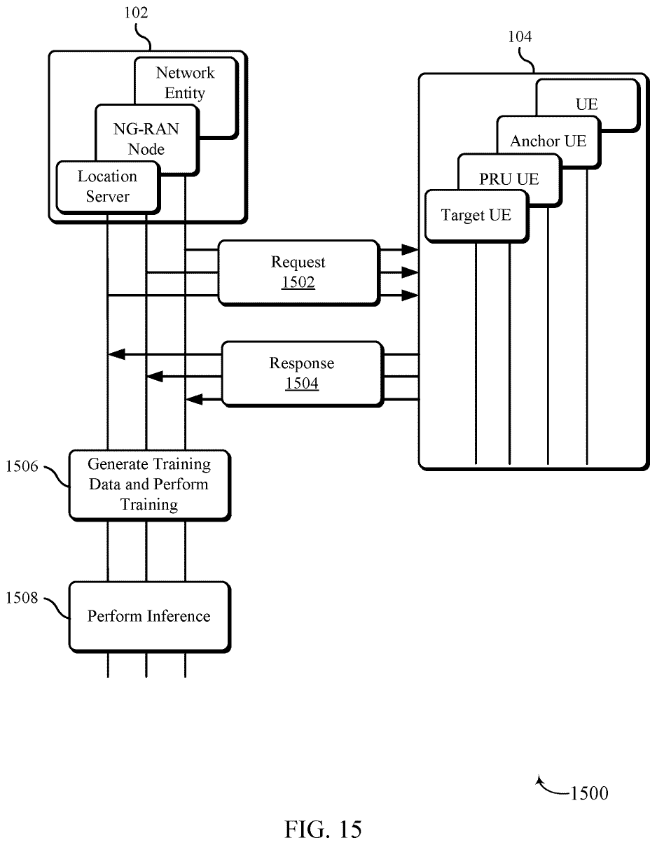

FIG. 15 illustrates a scenario 1500 that supports machine learning for positioning in accordance with aspects of the present disclosure. The scenario 1500, for instance, represents implementations for reporting exchange when network-side training is performed and network-side inference. In the scenario 1500 training and inference is performed at a network entity 102 (e.g., location server) and the network entity 102 may employ the illustrated signaling mechanisms to signal the direct AI/ML positioning report configuration as well as receive measurements from a UE 104, e.g., target UE, PRU UE, and so forth.

At 1502 the respective network entities 102 may request a plurality of direct AI/ML positioning measurements based on certain defined reporting criteria from a UE 104. In terms of signaling transport towards the UEs 104 for the requests 1502, LPP signaling may be employed while in scenarios for an NG-RAN node, RRC and/or related DL signaling such as DL MAC CE may be employed.

At 1504 the UE 104 may respond in kind to the requests 1502 received from the network entities 102, and provides as part of the responses 1504 measurements according to the reporting criteria and/or assistance information specified by the requests 1502.

At 1506 the network entity 102 constructs a training dataset based on measurement reports from different UEs 104 and performs training of an AI/ML model. At 1508 the network entity 102 performs inference based on new measurement data by repeating steps 1502, 1504. Alternatively, or additionally training and inference datasets may be requested in single shot.

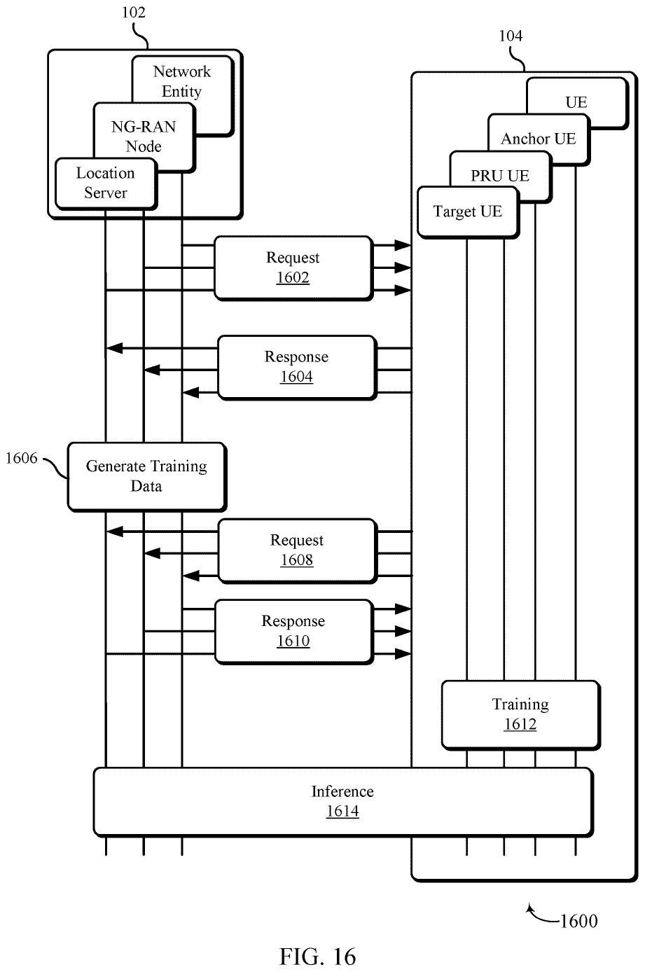

FIG. 16 illustrates a scenario 1600 that supports machine learning for positioning in accordance with aspects of the present disclosure. The scenario 1600, for instance, represents implementations for request and response procedures of stored AI/ML training datasets based on reported AI/ML measurements. In the scenario 1500 where training is performed at a UE 104 (e.g., PRU UE) the UE may employ the illustrated signaling as illustrated in the scenario 1600 and described below to receive AI/ML training dataset to perform training at the UE 104.

At 1602 the network entity 102 may request a plurality of direct AI/ML positioning measurements based on defined reporting criteria from a UE 104. In terms of signaling transport from the network entity 102 to the UE 104, LPP signaling may be employed and in scenarios for an NG-RAN node, RRC and/or related DL signaling such as DL MAC CE may be employed.

At 1604 the UE 104 may respond to the request 1602 from the network entities and provide measurements according to the reporting criteria and/or assistance information specified in the request 1602. At 1606 the network entity 102 constructs the training dataset based on measurement reports from different source UEs/nodes and stores the AI/ML training dataset. The storage of the training dataset may be associated with further additional validity criteria such as temporal criteria (e.g., time window, validity time duration, timer expiration) and/or spatial criteria, e.g., geographical region ID, area ID, cell ID, tracking area ID, system information area ID, zone-ID, AI-ML-Dataset-ValidityArea, or combinations thereof.

At 1608 in scenarios where training is performed at the UE 104 side, a UE 104 may request the AI/ML training dataset, which is based in part on the provided measurements from 1604. At 1610 the network entity 102 may respond to the request 1608 with the AI/ML training dataset, which can be based on certain criteria including the applicability of the training dataset to the UE 104 location, radio link quality, radio channel parameters, mobility pattern, orientation and so forth.

At 1612 the UE 104 performs training based on the received training dataset from the network entity 102 and at 1614 the network entity 102 and/or the UE 104 may perform inference to derive an estimated location of a target UE 104 based on the trained AI/ML model.

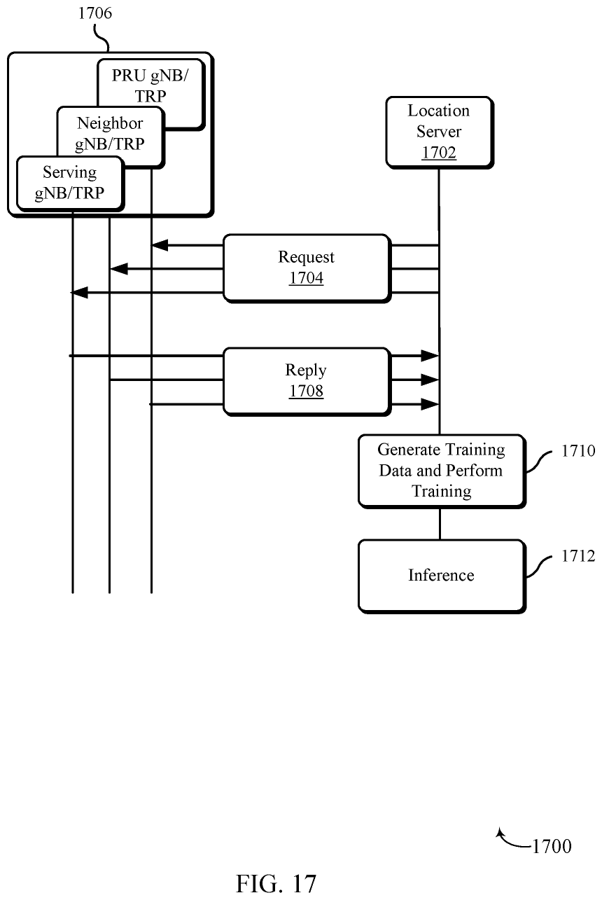

In implementations, the scenario 1600 may be applicable to scenarios where if the training is performed at an NG-RAN node, the NG-RAN node may request and receive a constructed training dataset stored at a location server (e.g., LMF) based in part on measurements the NG-RAN node provided to the location server, such as described below with reference to FIG. 17.

In implementations, model training may be performed at the UE side, where the signaling mechanisms in the scenario 1300b may be utilized to signal the direct AI/ML positioning report configuration as well as receive measurement from a network entity. One or more UEs 104 (e.g., a target UE) may provide a plurality of direct AI/ML measurements for inference at the network side.

In implementations various network entities and/or nodes may be enabled with the following procedures to enable a reporting configuration in scenarios where AI/ML model training and inference is performed at the network-side. For instance, the network entity (e.g., location server) may transmit a direct AI/ML positioning reporting configuration towards UEs and receive a corresponding report for DL and/or SL direct AI/ML positioning measurements, e.g., fingerprint measurements.

In scenarios for NG-RAN-assisted positioning, a location server may request a plurality of UL Direct AI/ML positioning measurements based on UL reference signals (e.g., SRS) for positioning from various data sources including neighboring gNBs/TRPs or NG-RAN nodes, PRU TRPs, CUs, DUs, or combinations thereof.

FIG. 17 illustrates a scenario 1700 that supports machine learning for positioning in accordance with aspects of the present disclosure. The scenario 1700, for instance, represents reporting exchange when LMF-side training is performed with LMF-side inference. In the scenario 1700, where training and inference is performed at a location server 1702, the location server 1702 may employ the illustrated signaling mechanisms to signal the UL direct AI/ML positioning report.

At 1704 the location server 1702 may request a plurality of UL direct AI/ML positioning measurements based on defined reporting criteria from an NG-RAN node 1706, e.g., a serving gNB/TRP, neighboring gNB/TRP, PRU gNB, TRP, etc. In terms of signaling transport towards the NG-RAN node 1706, NRPPa signaling may be employed, e.g., Positioning Measurement Request and Positioning Measurement Response messages.

At 1708 the NG-RAN node 1706 may respond to the request(s) 1704 from the location server 1702 and provide measurements according to the reporting criteria and/or assistance information such as specified in the request 1704.

At 1710 the location server 1702 constructs a training dataset based on measurement reports from different source NG-RAN nodes 1706 and performs training of an AI/ML model.

At 1712 the location server 1702 performs inference based on new measurement data by repeating steps 1704, 1706. In an implementation the training and inference datasets may be requested in single shot.

In implementations, where the training is performed at the NG-RAN node 1706, the NG-RAN node 1706 may request and receive UL direct AI/ML positioning measurement reports from the location server 1702, e.g., via NRPPa and/or other NG-RAN nodes, e.g., via the Xn interface.

In implementations various network entities and/or nodes may be enabled with the following procedures: The location server 1702 may transmit a direct AI/ML positioning reporting configuration towards a plurality of NG-RAN nodes 1706 and receive a corresponding report for UL direct AI/ML positioning measurements, e.g., fingerprint measurements.

In additional or alternatives implementations, the training dataset construction and training of the dataset may not necessarily occur at the same entity, and may occur in other separate network entities or nodes. For example, according to the scenarios 1400 Error! Reference source not found., a PRU UE, anchor UE, and/or other UE may perform the dataset construction or training of the dataset. Further, and similar to the scenario 1600, either a serving gNB/TRP, neighboring gNB/TRP or PRU gNB/TRP may perform the training dataset construction or training of the dataset. Further, the training dataset construction and inference of the AI/ML model may also follow the same behavior whereby they are not necessarily performed at the same entity. Alternatively or additionally, the report configuration methods discussed above can be combined in various ways, such as to utilize a plurality of DL, SL, and UL direct AI/ML positioning measurements in any one or more combinations.

Implementations described herein also provide for various ML-related reporting criteria. For instance, configurations for reporting criteria are detailed to support direct AI/ML position estimation, e.g., using fingerprinting methods.

In scenarios for UE-based positioning (e.g., with UE-sided model) the target UE may request a plurality of DL or SL direct AI/ML positioning measurements or other data required for training or inference. A set of common reporting criteria may be defined for network entities or UE/devices providing measurement reports for dataset construction.

TABLE 9
Common Reporting Criteria

| Parameter | Description |
|---|---|
| Fingerprint Type | This Information Element (IE) describes the |
| | type of fingerprints to be reported. This implies |
| | that the fingerprint is generated at the |
| | measurement entity/node and then reported to |
| | the target-UE. The fingerprint may comprise |
| | any one or more combinations of the following |
| | RAT-dependent DL/SL positioning |
| | measurements: RSTD, UE Rx-Tx time |
| | difference, ToA, RSS metrics such as PRS/SRS |
| | RSRP, RSRPP, RSSI, RSRQ, or AoD, AoA or |
| | RAT-independent measurements, e.g., A- |
| | GNSS, Bluetooth, WiFi, IMU sensor, etc. |
| | In one implementation, the reporting |
| | configuration entity may configure different |
| | measurements depending on the type of AI/ML |
| | model utilized, e.g., for AI/ML model A, RSS |
| | and timing-based measurements may |
| | characterize a fingerprint, while for AI/ML |
| | model B only RAT-independent measurements |
| | are utilized. In a different implementation, these |
| | fingerprints may be organized in a Hierarchical |
| | request of different fingerprints depending on |
| | the AI/ML model type. |
| Ground Truth/Reference | This IE describes the type of ground truth |
| Location Type | reference location, wherein each of the |
| | fingerprints or Direct AI/ML positioning |
| | measurements were obtained as referenced in |
| | TS 23.052 , including Ellipsoid point, Ellipsoid |
| | Point With Uncertainty Ellipse, Ellipsoid Point |
| | With Uncertainty Circle, Polygon, Ellipsoid |
| | Point With Altitude, Ellipsoid Point With |
| | Altitude and Uncertainty Ellipsoid, Ellipsoid |
| | Arc, High Accuracy Ellipsoid Point With |
| | Uncertainty Ellipse, High Accuracy Ellipsoid |
| | Point With Altitude and Uncertainty Ellipse, |
| | and so forth. |
| | In different implementations, the ground truth |
| | reference locations may correspond to 2D or 3D |
| | location points (including height/altitude). |
| Immediate Reporting | This time domain reporting IE indicates that |
| | Immediate reporting of Direct AI/ML including |
| | fingerprint measurements are requested based |
| | on the processed available measurements. |
| Periodical Reporting | This time domain reporting IE indicates that |
| | Periodical reporting of Direct AI/ML including |
| | fingerprint measurements are requested based |
| | on the processed available measurements. This |
| | may include further sub-fields such as |
| | Reporting Amount indicating the number of |
| | Direct AI/ML measurement reports, Reporting |
| | Interval indicating the periodicity or interval |
| | between Direct AI/ML measurement reports or |
| | combination thereof. In other implementation, |
| | periodical reports may be activated and |
| | deactivated in that case there is no reporting |
| | amount configured. |
| Triggered Reporting | This time domain reporting IE indicates that |
| | Triggered reporting of Direct AI/ML including |
| | fingerprint measurements are requested based |
| | on the processed available measurements. This |
| | may include further sub-fields such as |
| | geographical area change such as Cell ID, zone |
| | ID, new ground truth reference location or point |
| | or combination of changes thereof. Another |
| | sub-field may include a validity time associated |
| | to how long the triggered reporting is active or |
| | inactive. |
| Pre-processed | This IE indicates whether the measurement |
| Measurements | should pre-process the measurement, e.g., apply |
| | normalization to the measurement, and so forth. |
| | This IE can be in the form of a flag indicating |
| | whether to apply pre-processing or not. |
| | In one implementation, a further sub-field may |
| | include data cleaning, wherein the measurement |
| | entity is required to clean and prune the |
| | measurements before reporting, e.g., remove |
| | incorrect labels, misclassified data. This can be |
| | implementation for example in the form of a |
| | flag. |
| | In one implementation, the measurement entity |
| | can be requested to remove measurement biases |
| | or imbalances in the reported measurement |
| | dataset via a sub-field, e.g., via a Bias or |
| | sampling sub-field. |
| | In one implementation, another sub-field may |
| | include whether the measurement data requires |
| | normalization before reporting the plurality of |
| | Direct AI/ML measurements. |
| Fingerprint environment | This IE indicates the type of environment in |
| | which the Direct AI/ML or fingerprint |
| | measurements are to be reported, e.g., |
| | Indoor/Outdoor/Semi-Indoor/Semi-Outdoor, |
| | office, factory environment. Additional sub- |
| | fields may include floor plan information |
| | including the number of rooms, area, room |
| | heights. |
| Measurement Validity | This IE indicates the validity time of the Direct |
| | AI/ML/fingerprinting measurements to be |
| | reported. This may also be applicable to |
| | Assisted AI/ML positioning measurements. |
| | Assisted AI/ML positioning measurements may |
| | be defined as measurements, which have been |
| | enhanced and/or optimized using AI/ML |
| | models, e.g., RAT-dependent measurements |
| | such as RSTD, RTOA, RSRP, RSRPP, Rx-Tx, |
| | AoAs, AoDs, time difference and so forth. |
| UE-type | This IE indicates the UE-type configuration |
| | including antenna information, form factor, |
| | dimensions, handheld UE, CPE, and so forth. In |
| | another implementation, this may indicate |
| | whether the UE can report only DL positioning |
| | measurements, only SL positioning |
| | measurement or combination thereof. In another |
| | implementation, the UE-type may also indicate |
| | the role of the UE, e.g., PRU UE, normal UE, |
| | Anchor UE, Road-side Unit, SL Positioning |
| | Server UE, and so forth. |
| Number of reported | This IE indicates the number of Direct AI/ML |
| fingerprint measurements | or fingerprint measurements to be reported from |
| per ground truth reference | the measurement entity at a given ground truth |
| location | reference location. This can be signaled as a |
| | single value or min-max range, in which |
| | measurements are to be reported. In another |
| | implementation an index of ground truth |
| | reference locations can map to an index of |
| | number of measurements required at each |
| | location. |
| Mobility | This IE is used to report whether the |
| | measurements are reported depending on the |
| | measurement entity's mobility pattern type |
| | comprising of static, low, medium or high |
| | mobility patterns. A further sub-field may |
| | include horizontal/vertical velocity or |
| | acceleration parameters. |
| Orientation | This IE is used to report the measurement |
| | entity's orientation in terms of the Local |
| | coordinate system (LCS) or Global Coordinate |
| | System (GCS). This may extend to the overall |
| | orientation or the orientation of the antenna |
| | configurations with respect to the measurement |
| | entity or with respect to a global reference. |
| Fingerprint/Measurement | This IE is used to report the confidence in the |
| Quality | measurement or actual measurement quality |
| | depending on whether measurement is timing- |
| | based, angular based or RSS metric-based |
| | measurement. |
| | In another implementation, this field may be |
| | used to indicate the overall quality of a |
| | fingerprint comprising of one or more |
| | measurements. |
| Label Quality | This IE is used to report the label quality of a |
| | Direct AI/ML or Assisted AI/ML measurement. |
| | The quality may in the form of a confidence |
| | indicator, e.g., a binary indicator where ‘0’ |
| | refers to poor quality labels while ‘1’ refers to |
| | high quality labels or in the form of a soft |
| | indicator indicating the percentage quality of a |
| | label, e.g., 0%, 10%, 20% . . . 100%. |
| | In another implementation, where a label |
| | comprises a ground truth reference location, |
| | then the label quality corresponds to the |
| | location estimate quality depending on the |
| | location source and method used to derive the |
| | location, e.g., offline location input, RAT- |
| | dependent, RAT-independent methods, or |
| | combination thereof. |
| Fingerprint Quality | This IE is used to report the validity associated |
| Validity | to a fingerprint quality and may comprise of |
| | temporal validity criteria, e.g., time window, |
| | upon expiration of a timer, e.g., UTC time, |
| | GNSS time, etc. |
| | In another implementation, the validity |
| | associated with a fingerprint quality may be |
| | associated some spatial validity criteria, |
| | associated with the geo-graphical region in |
| | which the fingerprint was measured, e.g., cell |
| | ID, area ID, zone ID and so forth. |
| Label Quality Validity | This IE is used to report the validity associated |
| | to a label quality and may comprise of temporal |
| | validity criteria, e.g., time window, upon |
| | expiration of a timer, specified time base, e.g., |
| | UTC time, GNSS time, etc. |
| | In another implementation, the validity |
| | associated with a label quality may be |
| | associated some spatial validity criteria, |
| | associated with the geo-graphical region in |
| | which the fingerprint was measured, e.g., cell |
| | ID, area ID, zone ID and so forth. |

For scenarios for UE-assisted positioning, one or more of the common reporting criteria detailed in Table 9 may be signaled by a network entity, e.g., location server for reporting data types, e.g., measurement data.

For scenarios for NG-RAN-assisted positioning, one or more of the common reporting criteria detailed in Table 9 may be signaled by a network entity, e.g., location server to an NG-RAN node, e.g., gNB for reporting data types, e.g., measurement data.

In implementations, lower layer signaling with respect to LPP (e.g., RRC signaling, MAC CE, DCI signaling or combination thereof) may be used to convey the direct AI/ML reporting criteria configurations. In implementations, LPP or RRC signaling may be used to add, modify, remove, update, activate and/or deactivate one or more UE's Direct AI/ML positioning reporting configuration.

In implementations, the reporting criteria indicated in Table 9 and associated implementation details may be extended Assisted AI/ML positioning measurements for Cases, A, B, and C, where the positioning measurements are enhanced using a one or more AI/ML models.

In implementations, the common reporting criteria may be broadcasted via system information blocks (SIB) or positioning system information blocks (posSIBs) message to multiple UEs within a given geographic region, e.g., based on same cell ID, based on a system information area, based on Zone ID, or combination thereof.

Implementations also provide for reporting various assistance information related to direct AI/ML positioning measurements to assist in deriving a location estimate of the target UE. For instance, this may extend to scenarios where AI/ML assisted positioning measurements are being reported, where applicable.

In implementations a measurement entity (e.g., UE or NG-RAN node performing AI/ML positioning measurements) may be configured to report positioning measurement correlation amongst different sets of the measurements performed at the same measurement entity. This correlation metric, for instance, can be subject to UE capability. In at least one implementation, the measurement entity can report via a higher-layer parameter (e.g., LPP signaling) RSS-Correlation associated with a set of AI/ML positioning RSRP/RSSI measurements with each DL or SL PRS resource, e.g., DL resource ID. In scenarios for an NG-RAN node measurement, the RSS-Correlation may be associated with different sets of the UL RSS measurements with each UL resource, e.g., SRS resource ID. In extended implementations, the correlation metric may be applicable to timing-based (e.g., RSTD, ToA, etc.) or angular-based (e.g., AoA, AoD, etc.) measurements. The correlation measurement metric may be obtained per ground truth reference location in order to accurately and fairly compute the measurement correlation of multiple measurements taken at the same ground truth reference location.

In implementations, the positioning measurement correlation may be obtained from different UEs/devices at a same ground truth reference location. The measurements may be based at least in part on UE/NG-RAN node vendor-specific variations and therefore there may be variations of the same positioning measurement at the same ground truth reference location. In such implementations, the network entity or UE/device collecting the positioning measurements may correlate the different measurements received from difference network nodes/UEs/devices. The correlation may also be performed in the time domain (e.g., using a (sliding) time window) in addition to the spatial domain, e.g., based on location. In implementations, the measurement correlations between adjacent reference location points may also be configured, determined, and reported.

According to implementations, a measurement entity (e.g., UE and/or NG-RAN node) performing AI/ML positioning measurements may be configured to report associated channel characteristics to a direct AI/ML positioning measurement including whether the measurement is line of sight (LOS) or non-LOS (NLOS) based on a binary (e.g., hard decision) or soft indicator, link pathloss, channel coefficients or combination thereof. Reporting additional channel characteristics associated to a measurement can increase the stability and reliability of a reported AI/ML positioning measurement, e.g., an RSS measurement such as RSRP.

In implementations, the difference in path loss between a ground truth reference location point direct AI/ML (e.g., fingerprint measurement) and a target UE's measurement may be used to derive a PRS/SRS RSS measurement as a function of the Tx and Rx antenna gains, pathloss reference, pathloss exponents, standard deviation of fading parameters, e.g., shadow fading at the ground truth reference location point(s) and at the unknown target-UE location. One or more of the aforementioned parameters may be configured for reporting and reported to the requesting entity, e.g., UE/device or NG-RAN node or location server. In implementations, the measurement entity and/or target-UE may compute the path losses and report them to the requesting entity along with the direct AI/ML positioning measurement.

In implementations, the measurement entity (e.g., UE or NG-RAN node) performing AI/ML positioning measurements may be configured to report the average measurement at each ground truth reference location point over (N×Mᵢ)ⱼ, sample points, where N is configured sample of each measurement instance while M is the total number of measurements from each i^{th} gNB/TRP in the case of DL positioning measurements at each j^{th} ground truth reference location, while in the case of UL measurements M is the total number of measurements collected from each i^{th} UE. In implementations, additional statistical measures may be obtained over N×Mᵢ measurement points including variance, standard deviation, probability distribution functions, cumulative distribution functions and so forth at each reference location/point. N×Mᵢ may also be configurable using higher layer signaling such as LPP, RRC, SLPP or combination thereof.

In implementations, where the configured direct AI/ML positioning model includes k-NN in the supervised case or K-Means in the case of an unsupervised model, a network entity utilizing inference to determine a target-UE's location based on a set fingerprint data may use the following generalized distance formula according Minkowski's distance to derive the target-UE's location by processing the newly received measurements using:

$${d}_{Minkowski} ( x , y ) = {( {\sum }_{i = 1}^{n} {\vert {x}_{i} - {y}_{i} \vert}^{a} )}^{\frac{1}{a}} \qquad ( 1 )$$

where n is the total number of received measurements with a pair (x,y) parameters, while a can be configurable depending on which distance algorithm is utilized, e.g., if a=1, then the Manhattan distance approach is used while if a=2 then the Euclidean distance approach is used. In other implementations, the hamming distance or cosine distance and cosine similarity may be utilized to determine the similarity between multi-dimensional Direct AI/ML positioning data.

In implementations, whereby the online measurements are to be matched with the fingerprint measurements at each ground truth reference location/point, a similarity score based on the cumulative Manhattan distance in Eq. (1), where a=1 can be utilized to determine the target-UE's location, whereby the measurement entity is configured to report the minimum and maximum PRS/SRS RSS measurement out a total of M_{i,j} measurements where i refers to measurements originating from every i^{th} gNB/TRP or UE at each j^{th} ground truth reference location. The similarity score at each ground truth reference location (β_{Ref-Location}) can be given by the following mathematical relationship, where:

$${β}_{Ref - Location} ( j ) = ( \frac{{\sum }_{i = 1}^{n} ( \vert {P}_{i , min}^{AI / ML} - {P}_{T - UE , min}^{AI / ML} \vert + \vert {P}_{i , max}^{AI / ML} - {P}_{T - UE , max}^{AI / ML} \vert )}{n} ) \qquad ( 2 )$$

where

$${P}_{i , min}^{AI / ML}$$

is the minimum PRS or SRS RSS/fingerprint positioning measurement from the i^{th} gNB/TRP or UE, while

$${P}_{T - UE , min}^{AI / ML}$$

is the minimum sample positioning measurement from the set of measurements provided by the target-UE,

$${P}_{i , max}^{AI / ML}$$

is the maximum PRS or SRS RSS/fingerprint positioning measurement from the i^{th} gNB/TRP or UE, while

$${P}_{T - UE , max}^{AI / ML}$$

is the maximum sample positioning measurement from the set of measurements provided by the target-UE. The smallest value of β_{Ref-Location}(j) corresponds to the most likely location in which the target-UE may be located.

In implementations, β_{Ref-Location}(j) may be derived according to a pre-defined time window associated with a start time, window length, end time, periodicity in order to capture the variation of the positioning measurements and hence the similarity score over time.

In implementations, a first arrival path is considered for the above RSS measurements to be used as part of the fingerprinting training dataset. In implementations, the first arrival path and up to T configurable additional paths may be associated to a fingerprint RSS measurement and may be reported to the requesting network entity/node/UE.

In implementations, the measurement entity (e.g., a UE, PRU UE, or SL UE) may be configured to indicate if an RSS/fingerprint measurement (e.g., DL PRS RSRP) from a set of configured PRS resources within the same resource set has been measured with the same DL receive beam or same spatial filter for reception.

In implementations, the measurement, training, and/or inference entity may be configured to self-calibrate the direct or assisted AI/ML positioning measurements based on the provision of certain parameters for the purposes of inclusion in the training or inference dataset to a reference device, e.g., PRU UE. In at least one example, a linear calibration may be employed to may target-UE's measurement to that of a reference device such as a PRU UE, which can be represented as follows:

$${\overline{P}}_{PRU - UE , i , j}^{AI / ML} = {δ}_{T P} {\overline{P}}_{T - UE , i , j}^{AI / ML} + {μ}_{T P}$$

where

$${\overline{P}}_{T - UE , i , j}^{AI / ML}$$

denotes the mean target-UE PRS/SRS positioning measurement from the i^{th} gNB/TRP or UE at each j^{th} ground truth reference location,

$${\overline{P}}_{PRU - UE , i , j}^{AI / ML}$$

denotes the mean PKU UE PRS/SRS positioning measurement from the i^{th} gNB/TRP or UE at each j^{th} ground truth reference location, while δ_{TP} and μ_{TP} are the linear calibration parameters for mapping the RSS measurements from the target-UE to the PRU UE. This is especially useful if different network entities or UEs/devices are performing measurements from different vendors. The linear parameters, δ_{TP} and μ_{TP} may be configured to the measurement entity via higher layer signaling, e.g., LPP, NRPPa, SLPP, etc. to calibrate the measurements prior to reporting. The measurement, training, and/or inference entity may further receive a request to perform self-calibration of direct or assisted AI/ML positioning measurements. In another implementation, a non-linear function may also be utilized to self-calibrate direct or assisted AI/ML positioning measurements with similar procedures outlined for linear self-calibration in terms of the provision and reporting of the non-linear self-calibration parameters.

The RSS measurements mentioned in implementations described herein may include RSRP, RSRPP, RSSI, RSRQ values, which are associated with DL PRS, SL PRS or UL SRS.

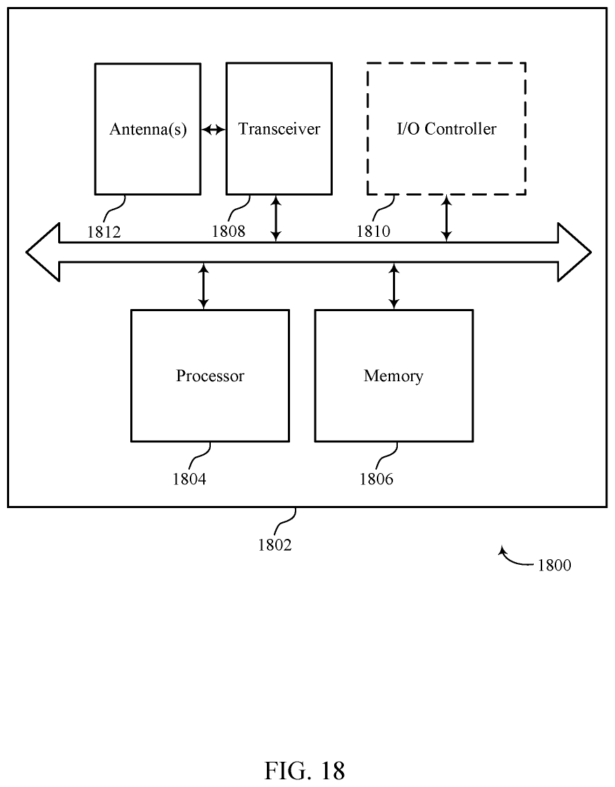

FIG. 18 illustrates an example of a block diagram 1800 of a device 1802 (e.g., an apparatus) that supports machine learning for positioning in accordance with aspects of the present disclosure. The device 1802 may be an example of UE 104 as described herein. The device 1802 may support wireless communication with one or more network entities 102, UEs 104, or any combination thereof. The device 1802 may include components for bi-directional communications including components for transmitting and receiving communications, such as a processor 1804, a memory 1806, a transceiver 1808, and an I/O controller 1810. These components may be in electronic communication or otherwise coupled (e.g., operatively, communicatively, functionally, electronically, electrically) via one or more interfaces (e.g., buses).

The processor 1804, the memory 1806, the transceiver 1808, or various combinations thereof or various components thereof may be examples of means for performing various aspects of the present disclosure as described herein. For example, the processor 1804, the memory 1806, the transceiver 1808, or various combinations or components thereof may support a method for performing one or more of the operations described herein.

In some implementations, the processor 1804, the memory 1806, the transceiver 1808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1804 and the memory 1806 coupled with the processor 1804 may be configured to perform one or more of the functions described herein (e.g., executing, by the processor 1804, instructions stored in the memory 1806). In the context of UE 104, for example, the transceiver 1808 and the processor coupled 1804 coupled to the transceiver 1808 are configured to cause the UE 104 to perform the various described operations and/or combinations thereof.

For example, the processor 1804 and/or the transceiver 1808 may support wireless communication at the device 1802 in accordance with examples as disclosed herein. For instance, the processor 1804 and/or the transceiver 1808 may be configured as and/or otherwise support a means to receive machine learning positioning configuration requests; and transmit, based at least in part on the machine learning positioning configuration requests, machine learning positioning configuration responses that include positioning reference signal configurations to be measured at respective reference locations and with one or more associated validity criteria.

Further, in some implementations, the processor is configured to cause the apparatus to receive the machine learning positioning configuration requests from one or more of network nodes or user equipment (UE) and to transmit the machine learning positioning configuration responses to the one or more of the network nodes or the UE; the reference locations include one or more ground truth reference locations; the machine learning positioning configuration responses include artificial intelligence configuration for the positioning reference signal configurations; the processor is configured to cause the apparatus to transmit one or more machine learning positioning configuration responses independent of a machine learning positioning configuration request; the machine learning positioning configuration responses include one or more of direct machine learning configuration or assisted machine learning configuration; the direct machine learning configuration includes configuration for performing radio frequency fingerprinting.

Further, in some implementations, the machine learning positioning configuration requests include a request for one or more of a training type, a ground truth location request, a machine learning method, a machine learning on-demand positioning reference signal request, or pre-configured machine learning assistance data; the positioning reference signal configurations include one or more of positioning reference signal resources, resource sets, transmission-reception points, or positioning frequency layer to be measured at each reference location; the one or more associated validity criteria include one or more of temporal criteria or spatial criteria; the temporal criteria include a measurement time defined by one or more a time bases; the one or more time bases include at least one of system frame number, coordinated universal time (UTC), or global navigation satellite systems (GNSS) time; the one or more associated validity criteria include a spatial criteria referring to an indication of a geographical region, and the spatial criteria include one or more of an area identifier, a cell identifier, or a zone identifier.

Further, in some implementations, the positioning reference signal configurations include one or more indications of one or more of uplink radio access technology-dependent measurements, downlink radio access technology-dependent measurements, or sidelink radio access technology-dependent measurements to be performed; the positioning reference signal configurations include one or more indications of one or more of downlink radio access technology-independent measurements or sidelink radio access technology-independent measurements to be performed; the machine learning positioning configuration responses further include one or more configurations pertaining to at least one of: a k-nearest neighbors (k-NN) algorithm, a support vector machine, a decision tree, a random forest, Gaussian mixture model, Bayesian Networks, an artificial neural network, K-means, reinforcement learning, deep learning, or transfer learning; the apparatus includes at least one of a location server, a next generation radio access network (NG-RAN), a positioning reference unit (PRU), a user equipment (UE) an anchor UE, or a target UE.

Further, in some implementations, the positioning reference signal configurations include a received signal strength indicator measurement for one or more of downlink, uplink, or sidelink; and the received signal strength indicator measurement for one or more of downlink, uplink, or sidelink is defined as including a linear average of a total received power observed in resource elements of a slot that carry positioning reference signal configured for measurement; the positioning reference signal configurations include a positioning reference signal time-of-arrival measurement for one or more of downlink, uplink, or sidelink; and the positioning reference signal time-of-arrival measurement for one or more of downlink, uplink, or sidelink is defined as including a reception time of a positioning reference signal at a receiver reference point; the positioning reference signal configurations include an indication that a location server is permitted to transmit an error cause related to a misconfiguration of a positioning reference signal configuration; the positioning reference signal configurations include an indication that a target user equipment (UE) is permitted to transmit an error cause related to an error in one or more of a reception a machine learning positioning configuration response or a measurement error related to a machine learning positioning measurement.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means to transmit a machine learning positioning configuration request; receive a machine learning positioning configuration response that includes a positioning reference signal configuration to be measured at one or more respective reference locations and with one or more associated validity criteria; and perform, based at least in part on the positioning reference signal configuration, one or more machine learning position measurements.

Further, in some implementations, the processor and the transceiver are configured to cause the apparatus to one or more of: receive the machine learning positioning configuration response in response to the machine learning positioning configuration request; or receive the machine learning positioning configuration response independent of the machine learning positioning configuration request; the processor is configured to cause the apparatus to input the one or more machine learning position measurements to a machine learning model and receive an output from the machine learning model; the processor is configured to cause the apparatus to generate an estimated location of the apparatus based at least in part on the output from the machine learning model; the apparatus includes one or more of a target user equipment (UE), a positioning reference unit (PRU), or an anchor UE.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means to transmit a configuration request to configure reference signals for machine learning positioning measurements; receive a configuration response including reference signal configuration; and transmit, based at least in part on the reference signal configuration, a reference signal transmission activation command.

Further, in some implementations, the reference signals include one or more of sounding reference signals or positioning reference signals; the processor is configured to cause the apparatus to transmit a reference signal transmission deactivation command; the apparatus includes a location server, and wherein the processor is configured to cause the apparatus to transmit the reference signal transmission activation command to one or more other apparatus that are configured to transmit the reference signals.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means to transmit one or more machine learning positioning report requests including a machine learning reporting configuration and one or more common reporting criteria; receive one or more machine learning positioning reports; process the one or more machine learning positioning reports via a machine learning model; and generate, based at least in part on output from the machine learning model, an estimated location of a user equipment (UE).

Further, in some implementations, the machine learning reporting configuration includes one or more of direct machine learning reporting configuration or assisted machine learning reporting configuration; the apparatus includes a configuration entity, and wherein the configuration entity includes at least one of a location server, a next generation radio access network (NG-RAN), a positioning reference unit (PRU), a UE, an anchor UE, or a target UE; the processor is configured to cause the apparatus to transmit the one or more machine learning positioning report requests to one or more second apparatus, and to receive the one or more machine learning positioning reports from the one or more second apparatus, and wherein the one or more second apparatus include at least one of a location server, a next generation radio access network (NG-RAN), a positioning reference unit (PRU), a UE, an anchor UE, or a target UE.

Further, in some implementations, the one or more common reporting criteria include one or more of a fingerprint type, a ground truth reference location type, a time domain reporting type, a pre-processing of measurements, a measurement validity, a UE type, a mobility indication, an orientation indication, a fingerprinting environment indication, a fingerprint quality indication, or a label quality indication; for at least one machine learning positioning report request, the one or more of the common reporting criteria are configured to be one or more of augmented, removed, updated, activated, or deactivated; the processor is configured to cause the apparatus to broadcast the one or more common reporting criteria via positioning system information broadcast signaling; the machine learning reporting configuration includes an indication to report machine learning positioning measurement correlation amongst different sets of measurements.

Further, in some implementations, the machine learning positioning measurement correlation includes one or more of spatial domain correlation or time domain correlation; the one or more machine learning positioning reports include one or more of machine learning positioning measurements or machine learning positioning location information; the machine learning reporting configuration includes an indication to report pathloss at different locations including a ground truth reference location; the machine learning reporting configuration includes an indication to average machine learning positioning measurements over a configured number of measurements and report the average as part of the one or more machine learning positioning reports; the machine learning reporting configuration includes an indication to determine a similarity score at a configured location to determine an optimal mapping between a fingerprint measurement and an estimated location of a target UE.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means to receive one or more machine learning positioning report requests including a machine learning reporting configuration and one or more common reporting criteria; generate one or more machine learning positioning reports based at least in part on the machine learning reporting configuration and the one or more common reporting criteria; and transmit the one or more machine learning positioning reports.

Further, in some implementations, the apparatus includes one or more of a user equipment (UE) an anchor UE, or a target UE; the apparatus includes a configuration entity, and wherein the configuration entity includes at least one of a location server, a next generation radio access network (NG-RAN), or a positioning reference unit (PRU).

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means to transmit one or more machine learning positioning report requests including a machine learning reporting configuration and one or more common reporting criteria; receive one or more machine learning positioning reports; generate, based at least in part on the one or more machine learning positioning reports, a machine learning positioning training data set; and train a positioning machine learning model using the machine learning positioning training data set to generate a trained positioning machine learning model.

Further, in some implementations, the processor and the transceiver are configured to cause the apparatus to receive one or more further machine learning positioning reports; input at least a portion of the one or more further machine learning positioning reports to the trained positioning machine learning model; and estimate a position of a target user equipment (UE) based at least in part on output from the trained positioning machine learning model; the processor is configured to cause the apparatus to: receive a request for machine learning positioning training data for positioning; and transmit, based at least in part on the request, the machine learning positioning training data set; the processor is configured to cause the apparatus to: receive a request for a trained positioning machine learning model; and transmit, based at least in part on the request, at least a portion of the trained positioning machine learning model.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for receiving machine learning positioning configuration requests; and transmitting, based at least in part on the machine learning positioning configuration requests, machine learning positioning configuration responses that include positioning reference signal configurations to be measured at respective reference locations and with one or more associated validity criteria.

Further, in some implementations, processor 1804 and/or the transceiver 1808, for instance, may be configured as or otherwise support a means for receiving the machine learning positioning configuration requests from one or more of network nodes or user equipment (UE) and transmitting the machine learning positioning configuration responses to the one or more of the network nodes or the UE; the reference locations include one or more ground truth reference locations; the machine learning positioning configuration responses include artificial intelligence configuration for the positioning reference signal configurations; transmitting one or more machine learning positioning configuration responses independent of a machine learning positioning configuration request; the machine learning positioning configuration responses include one or more of direct machine learning configuration or assisted machine learning configuration; the direct machine learning configuration includes configuration for performing radio frequency fingerprinting.

Further, in some implementations, the machine learning positioning configuration requests include a request for one or more of a training type, a ground truth location request, a machine learning method, a machine learning on-demand positioning reference signal request, or pre-configured machine learning assistance data; the positioning reference signal configurations include one or more of positioning reference signal resources, resource sets, transmission-reception points, or positioning frequency layer to be measured at each reference location; the one or more associated validity criteria include one or more of temporal criteria or spatial criteria; the temporal criteria include a measurement time defined by one or more a time bases; the one or more time bases include at least one of system frame number, coordinated universal time (UTC), or global navigation satellite systems (GNSS) time; the one or more associated validity criteria include a spatial criteria referring to an indication of a geographical region, and the spatial criteria include one or more of an area identifier, a cell identifier, or a zone identifier.

Further, in some implementations, the positioning reference signal configurations include one or more indications of one or more of uplink radio access technology-dependent measurements, downlink radio access technology-dependent measurements, or sidelink radio access technology-dependent measurements to be performed; the positioning reference signal configurations include one or more indications of one or more of downlink radio access technology-independent measurements or sidelink radio access technology-independent measurements to be performed; the machine learning positioning configuration responses further include one or more configurations pertaining to at least one of: a k-nearest neighbors (k-NN) algorithm, a support vector machine, a decision tree, a random forest, Gaussian mixture model, Bayesian Networks, an artificial neural network, K-means, reinforcement learning, deep learning, or transfer learning; the method is performed by an apparatus including at least one of a location server, a next generation radio access network (NG-RAN), a positioning reference unit (PRU), a user equipment (UE) an anchor UE, or a target UE.

Further, in some implementations, the positioning reference signal configurations include a received signal strength indicator measurement for one or more of downlink, uplink, or sidelink; and the received signal strength indicator measurement for one or more of downlink, uplink, or sidelink is defined as including a linear average of a total received power observed in resource elements of a slot that carry positioning reference signal configured for measurement; the positioning reference signal configurations include a positioning reference signal time-of-arrival measurement for one or more of downlink, uplink, or sidelink; and the positioning reference signal time-of-arrival measurement for one or more of downlink, uplink, or sidelink is defined as including a reception time of a positioning reference signal at a receiver reference point; the positioning reference signal configurations include an indication that a location server is permitted to transmit an error cause related to a misconfiguration of a positioning reference signal configuration; the positioning reference signal configurations include an indication that a target user equipment (UE) is permitted to transmit an error cause related to an error in one or more of a reception a machine learning positioning configuration response or a measurement error related to a machine learning positioning measurement.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for transmitting a machine learning positioning configuration request; receiving a machine learning positioning configuration response that includes a positioning reference signal configuration to be measured at one or more respective reference locations and with one or more associated validity criteria; and performing, based at least in part on the positioning reference signal configuration, one or more machine learning position measurements.

Further, in some implementations, processor 1804 and/or the transceiver 1808, for instance, may be configured as or otherwise support a means for one or more of: receiving the machine learning positioning configuration response in response to the machine learning positioning configuration request; or receiving the machine learning positioning configuration response independent of the machine learning positioning configuration request; inputting the one or more machine learning position measurements to a machine learning model and receiving an output from the machine learning model; generating an estimated location of the apparatus based at least in part on the output from the machine learning model; the method is performed by an apparatus including one or more of a target user equipment (UE), a positioning reference unit (PRU), or an anchor UE.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for transmitting a configuration request to configure reference signals for machine learning positioning measurements; receiving a configuration response including reference signal configuration; and transmitting, based at least in part on the reference signal configuration, a reference signal transmission activation command.

Further, in some implementations, the reference signals include one or more of sounding reference signals or positioning reference signals; transmitting a reference signal transmission deactivation command; the method is performed by an apparatus including a location server, and wherein the method further includes transmitting the reference signal transmission activation command to one or more other apparatus that are configured to transmit the reference signals.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for transmitting one or more machine learning positioning report requests including a machine learning reporting configuration and one or more common reporting criteria; receiving one or more machine learning positioning reports; processing the one or more machine learning positioning reports via a machine learning model; and generating, based at least in part on output from the machine learning model, an estimated location of a user equipment (UE).

Further, in some implementations, the machine learning reporting configuration includes one or more of direct machine learning reporting configuration or assisted machine learning reporting configuration; wherein the method if performed by an apparatus including a configuration entity, and wherein the configuration entity includes at least one of a location server, a next generation radio access network (NG-RAN), a positioning reference unit (PRU), a UE, an anchor UE, or a target UE; further including transmitting the one or more machine learning positioning report requests from a first apparatus to one or more second apparatus, and receiving the one or more machine learning positioning reports from the one or more second apparatus, and wherein the one or more second apparatus include at least one of a location server, a next generation radio access network (NG-RAN), a positioning reference unit (PRU), a UE, an anchor UE, or a target UE.

Further, in some implementations, the one or more common reporting criteria include one or more of a fingerprint type, a ground truth reference location type, a time domain reporting type, a pre-processing of measurements, a measurement validity, a UE type, a mobility indication, an orientation indication, a fingerprinting environment indication, a fingerprint quality indication, or a label quality indication; wherein for at least one machine learning positioning report request, the one or more of the common reporting criteria are configured to be one or more of augmented, removed, updated, activated, or deactivated; further including broadcasting the one or more common reporting criteria via positioning system information broadcast signaling; wherein the machine learning reporting configuration includes an indication to report machine learning positioning measurement correlation amongst different sets of measurements.

Further, in some implementations, the machine learning positioning measurement correlation includes one or more of spatial domain correlation or time domain correlation; wherein the one or more machine learning positioning reports include one or more of machine learning positioning measurements or machine learning positioning location information; wherein the machine learning reporting configuration includes an indication to report pathloss at different locations including a ground truth reference location; wherein the machine learning reporting configuration includes an indication to average machine learning positioning measurements over a configured number of measurements and report the average as part of the one or more machine learning positioning reports; wherein the machine learning reporting configuration includes an indication to determine a similarity score at a configured location to determine an optimal mapping between a fingerprint measurement and an estimated location of a target UE.

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for receiving one or more machine learning positioning report requests including a machine learning reporting configuration and one or more common reporting criteria; generating one or more machine learning positioning reports based at least in part on the machine learning reporting configuration and the one or more common reporting criteria; and transmitting the one or more machine learning positioning reports.

Further, in some implementations, the method is performed by an apparatus including one or more of a user equipment (UE) an anchor UE, or a target UE; wherein the method is performed by an apparatus including a configuration entity, and wherein the configuration entity includes at least one of a location server, a next generation radio access network (NG-RAN), or a positioning reference unit (PRU).

In a further example, the processor 1804 and/or the transceiver 1808 may support wireless communication at the device 1802 in accordance with examples as disclosed herein. The processor 1804 and/or the transceiver 1808, for instance, may be configured as or otherwise support a means for transmitting one or more machine learning positioning report requests including a machine learning reporting configuration and one or more common reporting criteria; receiving one or more machine learning positioning reports; generating, based at least in part on the one or more machine learning positioning reports, a machine learning positioning training data set; and training a positioning machine learning model using the machine learning positioning training data set to generate a trained positioning machine learning model.

Further, in some implementations, processor 1804 and/or the transceiver 1808, for instance, may be configured as or otherwise support a means for receiving one or more further machine learning positioning reports; inputting at least a portion of the one or more further machine learning positioning reports to the trained positioning machine learning model; and estimating a position of a target user equipment (UE) based at least in part on output from the trained positioning machine learning model; further including: receiving a request for machine learning positioning training data for positioning; and transmitting, based at least in part on the request, the machine learning positioning training data set; further including: receiving a request for a trained positioning machine learning model; and transmitting, based at least in part on the request, at least a portion of the trained positioning machine learning model.

The processor 1804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1804 may be configured to operate a memory array using a memory controller. In some other implementations, a memory controller may be integrated into the processor 1804. The processor 1804 may be configured to execute computer-readable instructions stored in a memory (e.g., the memory 1806) to cause the device 1802 to perform various functions of the present disclosure.

The memory 1806 may include random access memory (RAM) and read-only memory (ROM). The memory 1806 may store computer-readable, computer-executable code including instructions that, when executed by the processor 1804 cause the device 1802 to perform various functions described herein. The code may be stored in a non-transitory computer-readable medium such as system memory or another type of memory. In some implementations, the code may not be directly executable by the processor 1804 but may cause a computer (e.g., when compiled and executed) to perform functions described herein. In some implementations, the memory 1806 may include, among other things, a basic I/O system (BIOS) which may control basic hardware or software operation such as the interaction with peripheral components or devices.

The I/O controller 1810 may manage input and output signals for the device 1802. The I/O controller 1810 may also manage peripherals not integrated into the device M02. In some implementations, the I/O controller 1810 may represent a physical connection or port to an external peripheral. In some implementations, the I/O controller 1810 may utilize an operating system such as iOS®, ANDROID®, MS-DOS®, MS-WINDOWS®, OS/2®, UNIX®, LINUX®, or another known operating system. In some implementations, the I/O controller 1810 may be implemented as part of a processor, such as the processor M08. In some implementations, a user may interact with the device 1802 via the I/O controller 1810 or via hardware components controlled by the I/O controller 1810.

In some implementations, the device 1802 may include a single antenna 1812. However, in some other implementations, the device 1802 may have more than one antenna 1812 (e.g., multiple antennas), including multiple antenna panels or antenna arrays, which may be capable of concurrently transmitting or receiving multiple wireless transmissions. The transceiver 1808 may communicate bi-directionally, via the one or more antennas 1812, wired, or wireless links as described herein. For example, the transceiver 1808 may represent a wireless transceiver and may communicate bi-directionally with another wireless transceiver. The transceiver 1808 may also include a modem to modulate the packets, to provide the modulated packets to one or more antennas 1812 for transmission, and to demodulate packets received from the one or more antennas 1812.

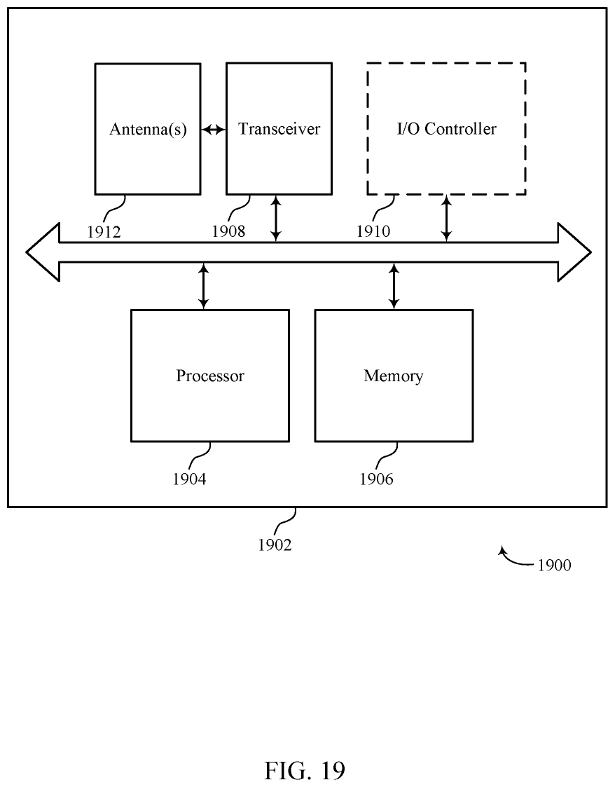

FIG. 19 illustrates an example of a block diagram 1900 of a device 1902 (e.g., an apparatus) that supports machine learning for positioning in accordance with aspects of the present disclosure. The device 1902 may be an example of a network entity 102 as described herein. The device 1902 may support wireless communication with one or more network entities 102, UEs 104, or any combination thereof. The device 1902 may include components for bi-directional communications including components for transmitting and receiving communications, such as a processor 1904, a memory 1906, a transceiver 1908, and an I/O controller 1910. These components may be in electronic communication or otherwise coupled (e.g., operatively, communicatively, functionally, electronically, electrically) via one or more interfaces (e.g., buses).

The processor 1904, the memory 1906, the transceiver 1908, or various combinations thereof or various components thereof may be examples of means for performing various aspects of the present disclosure as described herein. For example, the processor 1904, the memory 1906, the transceiver 1908, or various combinations or components thereof may support a method for performing one or more of the operations described herein.

In some implementations, the processor 1904, the memory 1906, the transceiver 1908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1904 and the memory 1906 coupled with the processor 1904 may be configured to perform one or more of the functions described herein (e.g., executing, by the processor 1904, instructions stored in the memory 1906). In the context of network entity 102, for example, the transceiver 1908 and the processor 1904 coupled to the transceiver 1908 are configured to cause the network entity 102 to perform the various described operations and/or combinations thereof.

For example, the processor 1904 and/or the transceiver 1908 may support wireless communication at the device 1902 in accordance with examples as disclosed herein. For instance, the processor 1904 and/or the transceiver 1908 may be configured as and/or otherwise support a means to receive machine learning positioning configuration requests; and transmit, based at least in part on the machine learning positioning configuration requests, machine learning positioning configuration responses that include positioning reference signal configurations to be measured at respective reference locations and with one or more associated validity criteria.

Further, in some implementations, the processor is configured to cause the apparatus to receive the machine learning positioning configuration requests from one or more of network nodes or user equipment (UE) and to transmit the machine learning positioning configuration responses to the one or more of the network nodes or the UE; the reference locations include one or more ground truth reference locations; the machine learning positioning configuration responses include artificial intelligence configuration for the positioning reference signal configurations; the processor is configured to cause the apparatus to transmit one or more machine learning positioning configuration responses independent of a machine learning positioning configuration request; the machine learning positioning configuration responses include one or more of direct machine learning configuration or assisted machine learning configuration; the direct machine learning configuration includes configuration for performing radio frequency fingerprinting.

Further, in some implementations, the machine learning positioning configuration requests include a request for one or more of a training type, a ground truth location request, a machine learning method, a machine learning on-demand positioning reference signal request, or pre-configured machine learning assistance data; the positioning reference signal configurations include one or more of positioning reference signal resources, resource sets, transmission-reception points, or positioning frequency layer to be measured at each reference location; the one or more associated validity criteria include one or more of temporal criteria or spatial criteria; the temporal criteria include a measurement time defined by one or more a time bases; the one or more time bases include at least one of system frame number, coordinated universal time (UTC), or global navigation satellite systems (GNSS) time; the one or more associated validity criteria include a spatial criteria referring to an indication of a geographical region, and the spatial criteria include one or more of an area identifier, a cell identifier, or a zone identifier.

Further, in some implementations, the positioning reference signal configurations include one or more indications of one or more of uplink radio access technology-dependent measurements, downlink radio access technology-dependent measurements, or sidelink radio access technology-dependent measurements to be performed; the positioning reference signal configurations include one or more indications of one or more of downlink radio access technology-independent measurements or sidelink radio access technology-independent measurements to be performed; the machine learning positioning configuration responses further include one or more configurations pertaining to at least one of: a k-nearest neighbors (k-NN) algorithm, a support vector machine, a decision tree, a random forest, Gaussian mixture model, Bayesian Networks, an artificial neural network, K-means, reinforcement learning, deep learning, or transfer learning; the apparatus includes at least one of a location server, a next generation radio access network (NG-RAN), a positioning reference unit (PRU), a user equipment (UE) an anchor UE, or a target UE.

Further, in some implementations, the positioning reference signal configurations include a received signal strength indicator measurement for one or more of downlink, uplink, or sidelink; and the received signal strength indicator measurement for one or more of downlink, uplink, or sidelink is defined as including a linear average of a total received power observed in resource elements of a slot that carry positioning reference signal configured for measurement; the positioning reference signal configurations include a positioning reference signal time-of-arrival measurement for one or more of downlink, uplink, or sidelink; and the positioning reference signal time-of-arrival measurement for one or more of downlink, uplink, or sidelink is defined as including a reception time of a positioning reference signal at a receiver reference point; the positioning reference signal configurations include an indication that a location server is permitted to transmit an error cause related to a misconfiguration of a positioning reference signal configuration; the positioning reference signal configurations include an indication that a target user equipment (UE) is permitted to transmit an error cause related to an error in one or more of a reception a machine learning positioning configuration response or a measurement error related to a machine learning positioning measurement.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means to transmit a machine learning positioning configuration request; receive a machine learning positioning configuration response that includes a positioning reference signal configuration to be measured at one or more respective reference locations and with one or more associated validity criteria; and perform, based at least in part on the positioning reference signal configuration, one or more machine learning position measurements.

Further, in some implementations, the processor and the transceiver are configured to cause the apparatus to one or more of: receive the machine learning positioning configuration response in response to the machine learning positioning configuration request; or receive the machine learning positioning configuration response independent of the machine learning positioning configuration request; the processor is configured to cause the apparatus to input the one or more machine learning position measurements to a machine learning model and receive an output from the machine learning model; the processor is configured to cause the apparatus to generate an estimated location of the apparatus based at least in part on the output from the machine learning model; the apparatus includes one or more of a target user equipment (UE), a positioning reference unit (PRU), or an anchor UE.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means to transmit a configuration request to configure reference signals for machine learning positioning measurements; receive a configuration response including reference signal configuration; and transmit, based at least in part on the reference signal configuration, a reference signal transmission activation command.

Further, in some implementations, the reference signals include one or more of sounding reference signals or positioning reference signals; the processor is configured to cause the apparatus to transmit a reference signal transmission deactivation command; the apparatus includes a location server, and wherein the processor is configured to cause the apparatus to transmit the reference signal transmission activation command to one or more other apparatus that are configured to transmit the reference signals.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means to transmit one or more machine learning positioning report requests including a machine learning reporting configuration and one or more common reporting criteria; receive one or more machine learning positioning reports; process the one or more machine learning positioning reports via a machine learning model; and generate, based at least in part on output from the machine learning model, an estimated location of a user equipment (UE).

Further, in some implementations, the machine learning reporting configuration includes one or more of direct machine learning reporting configuration or assisted machine learning reporting configuration; the apparatus includes a configuration entity, and wherein the configuration entity includes at least one of a location server, a next generation radio access network (NG-RAN), a positioning reference unit (PRU), a UE, an anchor UE, or a target UE; the processor is configured to cause the apparatus to transmit the one or more machine learning positioning report requests to one or more second apparatus, and to receive the one or more machine learning positioning reports from the one or more second apparatus, and wherein the one or more second apparatus include at least one of a location server, a next generation radio access network (NG-RAN), a positioning reference unit (PRU), a UE, an anchor UE, or a target UE.

Further, in some implementations, the one or more common reporting criteria include one or more of a fingerprint type, a ground truth reference location type, a time domain reporting type, a pre-processing of measurements, a measurement validity, a UE type, a mobility indication, an orientation indication, a fingerprinting environment indication, a fingerprint quality indication, or a label quality indication; for at least one machine learning positioning report request, the one or more of the common reporting criteria are configured to be one or more of augmented, removed, updated, activated, or deactivated; the processor is configured to cause the apparatus to broadcast the one or more common reporting criteria via positioning system information broadcast signaling; the machine learning reporting configuration includes an indication to report machine learning positioning measurement correlation amongst different sets of measurements.

Further, in some implementations, the machine learning positioning measurement correlation includes one or more of spatial domain correlation or time domain correlation; the one or more machine learning positioning reports include one or more of machine learning positioning measurements or machine learning positioning location information; the machine learning reporting configuration includes an indication to report pathloss at different locations including a ground truth reference location; the machine learning reporting configuration includes an indication to average machine learning positioning measurements over a configured number of measurements and report the average as part of the one or more machine learning positioning reports; the machine learning reporting configuration includes an indication to determine a similarity score at a configured location to determine an optimal mapping between a fingerprint measurement and an estimated location of a target UE.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means to receive one or more machine learning positioning report requests including a machine learning reporting configuration and one or more common reporting criteria; generate one or more machine learning positioning reports based at least in part on the machine learning reporting configuration and the one or more common reporting criteria; and transmit the one or more machine learning positioning reports.

Further, in some implementations, the apparatus includes one or more of a user equipment (UE) an anchor UE, or a target UE; the apparatus includes a configuration entity, and wherein the configuration entity includes at least one of a location server, a next generation radio access network (NG-RAN), or a positioning reference unit (PRU).

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means to transmit one or more machine learning positioning report requests including a machine learning reporting configuration and one or more common reporting criteria; receive one or more machine learning positioning reports; generate, based at least in part on the one or more machine learning positioning reports, a machine learning positioning training data set; and train a positioning machine learning model using the machine learning positioning training data set to generate a trained positioning machine learning model.

Further, in some implementations, the processor and the transceiver are configured to cause the apparatus to receive one or more further machine learning positioning reports; input at least a portion of the one or more further machine learning positioning reports to the trained positioning machine learning model; and estimate a position of a target user equipment (UE) based at least in part on output from the trained positioning machine learning model; the processor is configured to cause the apparatus to: receive a request for machine learning positioning training data for positioning; and transmit, based at least in part on the request, the machine learning positioning training data set; the processor is configured to cause the apparatus to: receive a request for a trained positioning machine learning model; and transmit, based at least in part on the request, at least a portion of the trained positioning machine learning model.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for receiving machine learning positioning configuration requests; and transmitting, based at least in part on the machine learning positioning configuration requests, machine learning positioning configuration responses that include positioning reference signal configurations to be measured at respective reference locations and with one or more associated validity criteria.

Further, in some implementations, processor 1904 and/or the transceiver 1908, for instance, may be configured as or otherwise support a means for receiving the machine learning positioning configuration requests from one or more of network nodes or user equipment (UE) and transmitting the machine learning positioning configuration responses to the one or more of the network nodes or the UE; the reference locations include one or more ground truth reference locations; the machine learning positioning configuration responses include artificial intelligence configuration for the positioning reference signal configurations; transmitting one or more machine learning positioning configuration responses independent of a machine learning positioning configuration request; the machine learning positioning configuration responses include one or more of direct machine learning configuration or assisted machine learning configuration; the direct machine learning configuration includes configuration for performing radio frequency fingerprinting.

Further, in some implementations, the machine learning positioning configuration requests include a request for one or more of a training type, a ground truth location request, a machine learning method, a machine learning on-demand positioning reference signal request, or pre-configured machine learning assistance data; the positioning reference signal configurations include one or more of positioning reference signal resources, resource sets, transmission-reception points, or positioning frequency layer to be measured at each reference location; the one or more associated validity criteria include one or more of temporal criteria or spatial criteria; the temporal criteria include a measurement time defined by one or more a time bases; the one or more time bases include at least one of system frame number, coordinated universal time (UTC), or global navigation satellite systems (GNSS) time; the one or more associated validity criteria include a spatial criteria referring to an indication of a geographical region, and the spatial criteria include one or more of an area identifier, a cell identifier, or a zone identifier.

Further, in some implementations, the positioning reference signal configurations include one or more indications of one or more of uplink radio access technology-dependent measurements, downlink radio access technology-dependent measurements, or sidelink radio access technology-dependent measurements to be performed; the positioning reference signal configurations include one or more indications of one or more of downlink radio access technology-independent measurements or sidelink radio access technology-independent measurements to be performed; the machine learning positioning configuration responses further include one or more configurations pertaining to at least one of: a k-nearest neighbors (k-NN) algorithm, a support vector machine, a decision tree, a random forest, Gaussian mixture model, Bayesian Networks, an artificial neural network, K-means, reinforcement learning, deep learning, or transfer learning; the method is performed by an apparatus including at least one of a location server, a next generation radio access network (NG-RAN), a positioning reference unit (PRU), a user equipment (UE) an anchor UE, or a target UE.

Further, in some implementations, the positioning reference signal configurations include a received signal strength indicator measurement for one or more of downlink, uplink, or sidelink; and the received signal strength indicator measurement for one or more of downlink, uplink, or sidelink is defined as including a linear average of a total received power observed in resource elements of a slot that carry positioning reference signal configured for measurement; the positioning reference signal configurations include a positioning reference signal time-of-arrival measurement for one or more of downlink, uplink, or sidelink; and the positioning reference signal time-of-arrival measurement for one or more of downlink, uplink, or sidelink is defined as including a reception time of a positioning reference signal at a receiver reference point; the positioning reference signal configurations include an indication that a location server is permitted to transmit an error cause related to a misconfiguration of a positioning reference signal configuration; the positioning reference signal configurations include an indication that a target user equipment (UE) is permitted to transmit an error cause related to an error in one or more of a reception a machine learning positioning configuration response or a measurement error related to a machine learning positioning measurement.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for transmitting a machine learning positioning configuration request; receiving a machine learning positioning configuration response that includes a positioning reference signal configuration to be measured at one or more respective reference locations and with one or more associated validity criteria; and performing, based at least in part on the positioning reference signal configuration, one or more machine learning position measurements.

Further, in some implementations, processor 1904 and/or the transceiver 1908, for instance, may be configured as or otherwise support a means for one or more of: receiving the machine learning positioning configuration response in response to the machine learning positioning configuration request; or receiving the machine learning positioning configuration response independent of the machine learning positioning configuration request; inputting the one or more machine learning position measurements to a machine learning model and receiving an output from the machine learning model; generating an estimated location of the apparatus based at least in part on the output from the machine learning model; the method is performed by an apparatus including one or more of a target user equipment (UE), a positioning reference unit (PRU), or an anchor UE.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for transmitting a configuration request to configure reference signals for machine learning positioning measurements; receiving a configuration response including reference signal configuration; and transmitting, based at least in part on the reference signal configuration, a reference signal transmission activation command.

Further, in some implementations, the reference signals include one or more of sounding reference signals or positioning reference signals; transmitting a reference signal transmission deactivation command; the method is performed by an apparatus including a location server, and wherein the method further includes transmitting the reference signal transmission activation command to one or more other apparatus that are configured to transmit the reference signals.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for transmitting one or more machine learning positioning report requests including a machine learning reporting configuration and one or more common reporting criteria; receiving one or more machine learning positioning reports; processing the one or more machine learning positioning reports via a machine learning model; and generating, based at least in part on output from the machine learning model, an estimated location of a user equipment (UE).

Further, in some implementations, the machine learning reporting configuration includes one or more of direct machine learning reporting configuration or assisted machine learning reporting configuration; wherein the method if performed by an apparatus including a configuration entity, and wherein the configuration entity includes at least one of a location server, a next generation radio access network (NG-RAN), a positioning reference unit (PRU), a UE, an anchor UE, or a target UE; further including transmitting the one or more machine learning positioning report requests from a first apparatus to one or more second apparatus, and receiving the one or more machine learning positioning reports from the one or more second apparatus, and wherein the one or more second apparatus include at least one of a location server, a next generation radio access network (NG-RAN), a positioning reference unit (PRU), a UE, an anchor UE, or a target UE.

Further, in some implementations, the one or more common reporting criteria include one or more of a fingerprint type, a ground truth reference location type, a time domain reporting type, a pre-processing of measurements, a measurement validity, a UE type, a mobility indication, an orientation indication, a fingerprinting environment indication, a fingerprint quality indication, or a label quality indication; wherein for at least one machine learning positioning report request, the one or more of the common reporting criteria are configured to be one or more of augmented, removed, updated, activated, or deactivated; further including broadcasting the one or more common reporting criteria via positioning system information broadcast signaling; wherein the machine learning reporting configuration includes an indication to report machine learning positioning measurement correlation amongst different sets of measurements.

Further, in some implementations, the machine learning positioning measurement correlation includes one or more of spatial domain correlation or time domain correlation; wherein the one or more machine learning positioning reports include one or more of machine learning positioning measurements or machine learning positioning location information; wherein the machine learning reporting configuration includes an indication to report pathloss at different locations including a ground truth reference location; wherein the machine learning reporting configuration includes an indication to average machine learning positioning measurements over a configured number of measurements and report the average as part of the one or more machine learning positioning reports; wherein the machine learning reporting configuration includes an indication to determine a similarity score at a configured location to determine an optimal mapping between a fingerprint measurement and an estimated location of a target UE.

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for receiving one or more machine learning positioning report requests including a machine learning reporting configuration and one or more common reporting criteria; generating one or more machine learning positioning reports based at least in part on the machine learning reporting configuration and the one or more common reporting criteria; and transmitting the one or more machine learning positioning reports.

Further, in some implementations, the method is performed by an apparatus including one or more of a user equipment (UE) an anchor UE, or a target UE; wherein the method is performed by an apparatus including a configuration entity, and wherein the configuration entity includes at least one of a location server, a next generation radio access network (NG-RAN), or a positioning reference unit (PRU).

In a further example, the processor 1904 and/or the transceiver 1908 may support wireless communication at the device 1902 in accordance with examples as disclosed herein. The processor 1904 and/or the transceiver 1908, for instance, may be configured as or otherwise support a means for transmitting one or more machine learning positioning report requests including a machine learning reporting configuration and one or more common reporting criteria; receiving one or more machine learning positioning reports; generating, based at least in part on the one or more machine learning positioning reports, a machine learning positioning training data set; and training a positioning machine learning model using the machine learning positioning training data set to generate a trained positioning machine learning model.

Further, in some implementations, processor 1904 and/or the transceiver 1908, for instance, may be configured as or otherwise support a means for receiving one or more further machine learning positioning reports; inputting at least a portion of the one or more further machine learning positioning reports to the trained positioning machine learning model; and estimating a position of a target user equipment (UE) based at least in part on output from the trained positioning machine learning model; further including: receiving a request for machine learning positioning training data for positioning; and transmitting, based at least in part on the request, the machine learning positioning training data set; further including: receiving a request for a trained positioning machine learning model; and transmitting, based at least in part on the request, at least a portion of the trained positioning machine learning model.

The processor 1904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1904 may be configured to operate a memory array using a memory controller. In some other implementations, a memory controller may be integrated into the processor 1904. The processor 1904 may be configured to execute computer-readable instructions stored in a memory (e.g., the memory 1906) to cause the device 1902 to perform various functions of the present disclosure.

The memory 1906 may include random access memory (RAM) and read-only memory (ROM). The memory 1906 may store computer-readable, computer-executable code including instructions that, when executed by the processor 1904 cause the device 1902 to perform various functions described herein. The code may be stored in a non-transitory computer-readable medium such as system memory or another type of memory. In some implementations, the code may not be directly executable by the processor 1904 but may cause a computer (e.g., when compiled and executed) to perform functions described herein. In some implementations, the memory 1906 may include, among other things, a basic I/O system (BIOS) which may control basic hardware or software operation such as the interaction with peripheral components or devices.

The I/O controller 1910 may manage input and output signals for the device 1902. The I/O controller 1910 may also manage peripherals not integrated into the device M02. In some implementations, the I/O controller 1910 may represent a physical connection or port to an external peripheral. In some implementations, the I/O controller 1910 may utilize an operating system such as iOS®, ANDROID®, MS-DOS®, MS-WINDOWS®, OS/2®, UNIX®, LINUX®, or another known operating system. In some implementations, the I/O controller 1910 may be implemented as part of a processor, such as the processor M06. In some implementations, a user may interact with the device 1902 via the I/O controller 1910 or via hardware components controlled by the I/O controller 1910.

In some implementations, the device 1902 may include a single antenna 1912. However, in some other implementations, the device 1902 may have more than one antenna 1912 (e.g., multiple antennas), including multiple antenna panels or antenna arrays, which may be capable of concurrently transmitting or receiving multiple wireless transmissions. The transceiver 1908 may communicate bi-directionally, via the one or more antennas 1912, wired, or wireless links as described herein. For example, the transceiver 1908 may represent a wireless transceiver and may communicate bi-directionally with another wireless transceiver. The transceiver 1908 may also include a modem to modulate the packets, to provide the modulated packets to one or more antennas 1912 for transmission, and to demodulate packets received from the one or more antennas 1912.

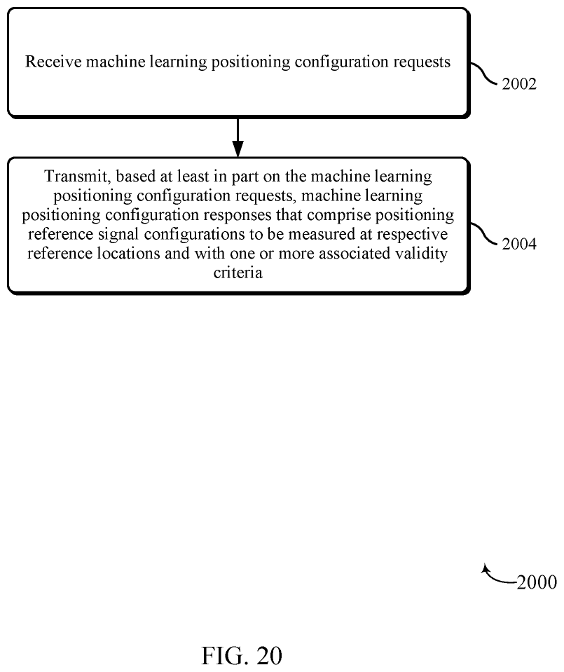

FIG. 20 illustrates a flowchart of a method 2000 that supports machine learning for positioning in accordance with aspects of the present disclosure. The operations of the method 2000 may be implemented by a device or its components as described herein. For example, the operations of the method 2000 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2002, the method may include receiving machine learning positioning configuration requests. The operations of 2002 may be performed in accordance with examples as described herein. In some implementations, aspects of the operations of 2002 may be performed by a device as described with reference to FIG. 1.

At 2004, the method may include transmitting, based at least in part on the machine learning positioning configuration requests, machine learning positioning configuration responses that comprise positioning reference signal configurations to be measured at respective reference locations and with one or more associated validity criteria. The operations of 2004 may be performed in accordance with examples as described herein. In some implementations, aspects of the operations of 2004 may be performed by a device as described with reference to FIG. 1.

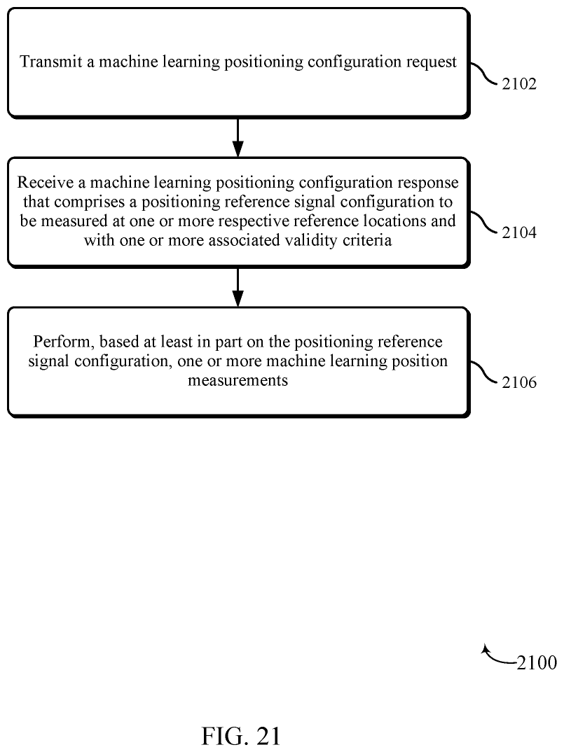

FIG. 21 illustrates a flowchart of a method 2100 that supports machine learning for positioning in accordance with aspects of the present disclosure. The operations of the method 2100 may be implemented by a device or its components as described herein. For example, the operations of the method 2100 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2102, the method may include transmitting a machine learning positioning configuration request. The operations of 2102 may be performed in accordance with examples as described herein. In some implementations, aspects of the operations of 2102 may be performed by a device as described with reference to FIG. 1.

At 2104, the method may include receiving a machine learning positioning configuration response that comprises a positioning reference signal configuration to be measured at one or more respective reference locations and with one or more associated validity criteria. The operations of 2104 may be performed in accordance with examples as described herein. In some implementations, aspects of the operations of 2104 may be performed by a device as described with reference to FIG. 1.

At 2106, the method may include performing, based at least in part on the positioning reference signal configuration, one or more machine learning position measurements. The operations of 2106 may be performed in accordance with examples as described herein. In some implementations, aspects of the operations of 2106 may be performed by a device as described with reference to FIG. 1.

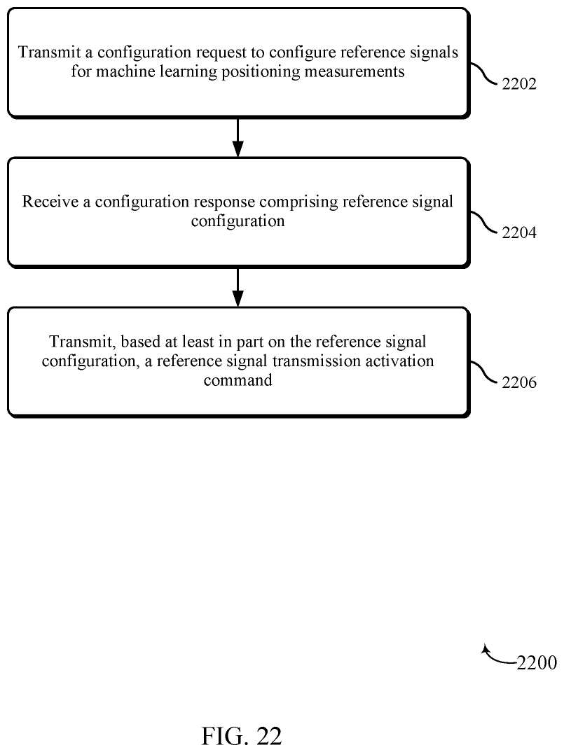

FIG. 22 illustrates a flowchart of a method 2200 that supports machine learning for positioning in accordance with aspects of the present disclosure. The operations of the method 2200 may be implemented by a device or its components as described herein. For example, the operations of the method 2200 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2202, the method may include transmitting a configuration request to configure reference signals for machine learning positioning measurements. The operations of 2202 may be performed in accordance with examples as described herein. In some implementations, aspects of the operations of 2202 may be performed by a device as described with reference to FIG. 1.

At 2204, the method may include receiving a configuration response comprising reference signal configuration. The operations of 2204 may be performed in accordance with examples as described herein. In some implementations, aspects of the operations of 2204 may be performed by a device as described with reference to FIG. 1.

At 2206, the method may include transmitting, based at least in part on the reference signal configuration, a reference signal transmission activation command. The operations of 2206 may be performed in accordance with examples as described herein. In some implementations, aspects of the operations of 2206 may be performed by a device as described with reference to FIG. 1.

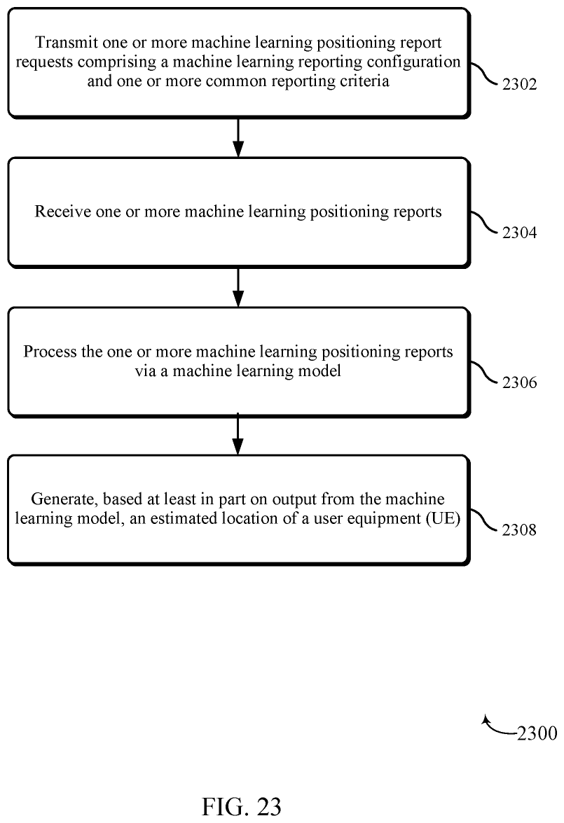

FIG. 23 illustrates a flowchart of a method 2300 that supports machine learning for positioning in accordance with aspects of the present disclosure. The operations of the method 2300 may be implemented by a device or its components as described herein. For example, the operations of the method 2300 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2302, the method may include transmitting one or more machine learning positioning report requests comprising a machine learning reporting configuration and one or more common reporting criteria. The operations of 2302 may be performed in accordance with examples as described herein. In some implementations, aspects of the operations of 2302 may be performed by a device as described with reference to FIG. 1.

At 2304, the method may include receiving one or more machine learning positioning reports. The operations of 2304 may be performed in accordance with examples as described herein. In some implementations, aspects of the operations of 2304 may be performed by a device as described with reference to FIG. 1.

At 2306, the method may include processing the one or more machine learning positioning reports via a machine learning model. The operations of 2306 may be performed in accordance with examples as described herein. In some implementations, aspects of the operations of 2306 may be performed by a device as described with reference to FIG. 1.

At 2308, the method may include generating, based at least in part on output from the machine learning model, an estimated location of a user equipment (UE). The operations of 2308 may be performed in accordance with examples as described herein. In some implementations, aspects of the operations of 2308 may be performed by a device as described with reference to FIG. 1.

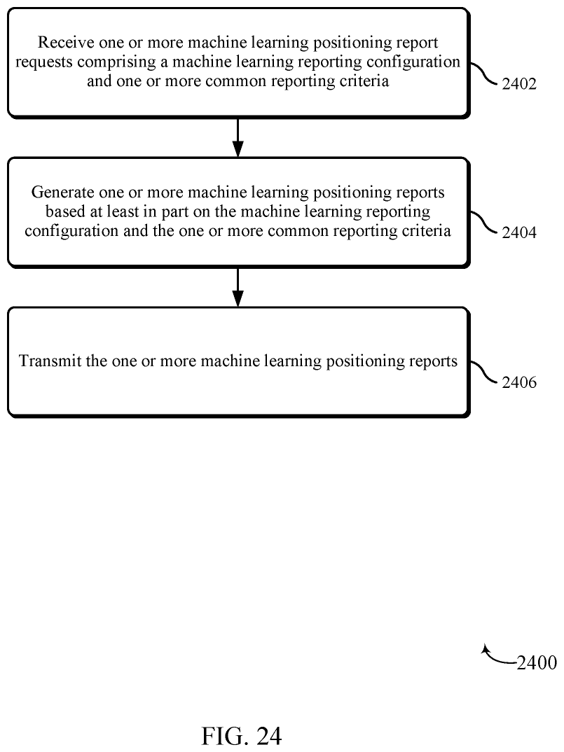

FIG. 24 illustrates a flowchart of a method 2400 that supports machine learning for positioning in accordance with aspects of the present disclosure. The operations of the method 2400 may be implemented by a device or its components as described herein. For example, the operations of the method 2400 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2402, the method may include receiving one or more machine learning positioning report requests comprising a machine learning reporting configuration and one or more common reporting criteria. The operations of 2402 may be performed in accordance with examples as described herein. In some implementations, aspects of the operations of 2402 may be performed by a device as described with reference to FIG. 1.

At 2404, the method may include generating one or more machine learning positioning reports based at least in part on the machine learning reporting configuration and the one or more common reporting criteria. The operations of 2404 may be performed in accordance with examples as described herein. In some implementations, aspects of the operations of 2404 may be performed by a device as described with reference to FIG. 1.

At 2406, the method may include transmitting the one or more machine learning positioning reports. The operations of 2406 may be performed in accordance with examples as described herein. In some implementations, aspects of the operations of 2406 may be performed by a device as described with reference to FIG. 1.

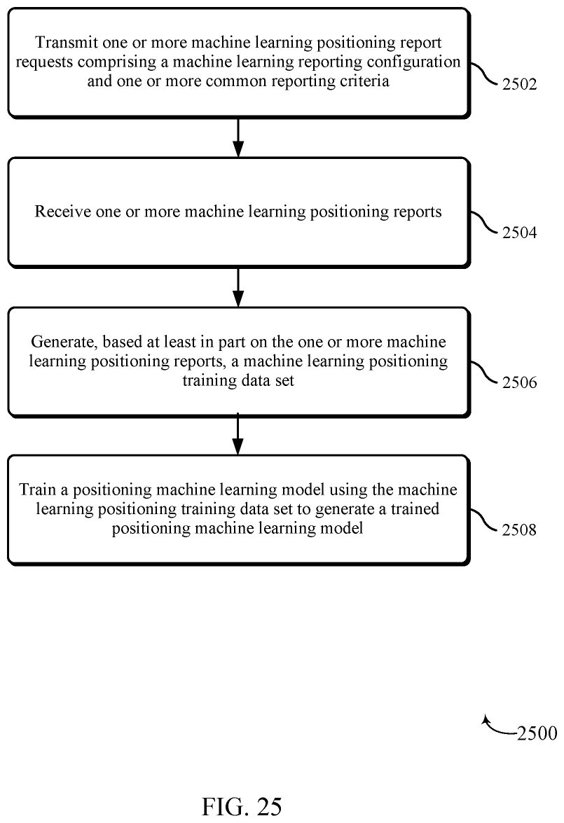

FIG. 25 illustrates a flowchart of a method 2500 that supports machine learning for positioning in accordance with aspects of the present disclosure. The operations of the method 2500 may be implemented by a device or its components as described herein. For example, the operations of the method 2500 may be performed by a network entity 102 and/or a UE 104 as described with reference to FIGS. 1 through 19. In some implementations, the device may execute a set of instructions to control the function elements of the device to perform the described functions. Additionally, or alternatively, the device may perform aspects of the described functions using special-purpose hardware.

At 2502, the method may include transmitting one or more machine learning positioning report requests comprising a machine learning reporting configuration and one or more common reporting criteria. The operations of 2502 may be performed in accordance with examples as described herein. In some implementations, aspects of the operations of 2502 may be performed by a device as described with reference to FIG. 1.

At 2504, the method may include receiving one or more machine learning positioning reports. The operations of 2504 may be performed in accordance with examples as described herein. In some implementations, aspects of the operations of 2504 may be performed by a device as described with reference to FIG. 1.

At 2506, the method may include generating, based at least in part on the one or more machine learning positioning reports, a machine learning positioning training data set. The operations of 2506 may be performed in accordance with examples as described herein. In some implementations, aspects of the operations of 2506 may be performed by a device as described with reference to FIG. 1.

At 2508, the method may include training a positioning machine learning model using the machine learning positioning training data set to generate a trained positioning machine learning model. The operations of 2508 may be performed in accordance with examples as described herein. In some implementations, aspects of the operations of 2508 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1-20. (canceled)

21. An apparatus comprising:
at least one memory; and
at least one processor coupled with the at least one memory and operable to cause the apparatus to:
transmit one or more machine learning positioning report requests comprising a machine learning reporting configuration and one or more common reporting criteria;
receive one or more machine learning positioning reports;
process the one or more machine learning positioning reports via a machine learning model; and
generate, based at least in part on output from the machine learning model, an estimated location of a user equipment (UE).

22. The apparatus of claim 21, wherein the machine learning reporting configuration comprises one or more of direct machine learning reporting configuration or assisted machine learning reporting configuration.

23. The apparatus of claim 21, wherein the apparatus comprises a configuration entity, and wherein the configuration entity comprises at least one of a location server, a next generation radio access network (NG-RAN), a positioning reference unit (PRU), a UE, an anchor UE, or a target UE.

24. The apparatus of claim 21, wherein the at least one processor is operable to cause the apparatus to:
transmit the one or more machine learning positioning report requests to one or more second apparatus; and
receive the one or more machine learning positioning reports from the one or more second apparatus,
wherein the one or more second apparatus comprise at least one of a location server, a next generation radio access network (NG-RAN), a positioning reference unit (PRU), a UE, an anchor UE, or a target UE.

25. The apparatus of claim 21, wherein the at least one processor is operable to cause the apparatus to broadcast the one or more common reporting criteria via positioning system information broadcast signaling.

26. The apparatus of claim 21, wherein the one or more machine learning positioning reports comprise one or more of machine learning positioning measurements or machine learning positioning location information.

27. An apparatus comprising:
at least one memory; and
at least one processor coupled with the at least one memory and operable to cause the apparatus to:
receive one or more machine learning positioning report requests comprising a machine learning reporting configuration and one or more common reporting criteria;
generate one or more machine learning positioning reports based at least in part on the machine learning reporting configuration and the one or more common reporting criteria; and
transmit the one or more machine learning positioning reports.

28. The apparatus of claim 27, wherein the apparatus comprises one or more of a user equipment (UE) an anchor UE, or a target UE.

29. The apparatus of claim 27, wherein the apparatus comprises a configuration entity, and wherein the configuration entity comprises at least one of a location server, a next generation radio access network (NG-RAN), or a positioning reference unit (PRU).

30. A method for wireless communication, the method comprising:
transmitting one or more machine learning positioning report requests comprising a machine learning reporting configuration and one or more common reporting criteria;
receiving one or more machine learning positioning reports;
processing the one or more machine learning positioning reports via a machine learning model; and
generating, based at least in part on output from the machine learning model, an estimated location of a user equipment (UE).

31. The method of claim 30, wherein the machine learning reporting configuration comprises one or more of direct machine learning reporting configuration or assisted machine learning reporting configuration.

32. The method of claim 30, wherein the method is performed by a configuration entity, and wherein the configuration entity comprises at least one of a location server, a next generation radio access network (NG-RAN), a positioning reference unit (PRU), a UE, an anchor UE, or a target UE.

33. The method of claim 30, further comprising:
transmitting the one or more machine learning positioning report requests to one or more second apparatus; and
receiving the one or more machine learning positioning reports from the one or more second apparatus,
wherein the one or more second apparatus comprise at least one of a location server, a next generation radio access network (NG-RAN), a positioning reference unit (PRU), a UE, an anchor UE, or a target UE.

34. The method of claim 30, wherein the one or more machine learning positioning reports comprise one or more of machine learning positioning measurements or machine learning positioning location information.

35. The method of claim 30, further comprising broadcasting the one or more common reporting criteria via positioning system information broadcast signaling.

36. The method of claim 30, further comprising:
receiving a request for machine learning positioning training data for positioning; and
transmitting, based at least in part on the request, a machine learning positioning training data set.

37. The method of claim 30, further comprising:
receiving a request for a trained positioning machine learning model; and
transmit, based at least in part on the request, at least a portion of a trained positioning machine learning model.

38. A method for wireless communication, the method comprising:
receiving one or more machine learning positioning report requests comprising a machine learning reporting configuration and one or more common reporting criteria;
generating one or more machine learning positioning reports based at least in part on the machine learning reporting configuration and the one or more common reporting criteria; and
transmitting the one or more machine learning positioning reports.

39. The method of claim 38, wherein the method is performed by an apparatus, and the apparatus comprises one or more of a user equipment (UE) an anchor UE, or a target UE.

40. The method of claim 38, wherein the method is performed by an apparatus, the apparatus comprises a configuration entity, and the configuration entity comprises at least one of a location server, a next generation radio access network (NG-RAN), or a positioning reference unit (PRU).
